(19) United States
(12) Patent Application Publication
(10) Pub. No.: US 2026/0158738 A1
(43) Pub. Date: Jun. 11, 2026

(54) A METHOD FOR MANUFACTURING A THREE-DIMENSIONAL OBJECT

(71) Applicant: xolo GmbH, Berlin (DE)

(72) Inventors: Yves Garmshausen, Berlin (DE); Eric Israel, Berlin (DE)

(73) Assignee: xolo GmbH, Berlin (DE)

(21) Appl. No.: 19/512,867

(22) PCT Filed: Aug. 15, 2024
(86) PCT No.: PCT/EP2024/072975

§ 371 Date: Feb. 20, 2026

(30) Foreign Application Priority Data
Aug. 16, 2023 (DE) 10 2023 121 854.9

(51) Int. Cl. B29C 64/194; B29C 64/124; B29C 71/00; B29C 71/02; B29C 71/04; B33Y 10/00; B33Y 40/10; B33Y 40/20; B33Y 70/00

(52) U.S. Cl. CPC B29C 64/194; B29C 64/124; B29C 71/0009; B29C 71/02; B29C 71/04; B29C 2071/027; B33Y 10/00; B33Y 40/10; B33Y 40/20; B33Y 70/00

(57) ABSTRACT

A method for manufacturing a three-dimensional object, the method comprising: a) a volumetric 3d-printing process in which a photopolymerizable material is irradiated with light of at least one wavelength for photopolymerizing the photopolymerizable material to form a three-dimensional object, the three-dimensional object manufactured in accordance with the volumetric 3d-printing process having specific optical properties.

### FIELD OF INVENTION

The invention relates to a method for manufacturing a three-dimensional object, the method comprises a volumetric 3d-printing process in which a photopolymerizable material is irradiated with light of at least one wavelength for photopolymerizing the photopolymerizable material to form a three-dimensional object, the three-dimensional object manufactured in accordance with the volumetric 3d-printing process having specific optical properties.

### BACKGROUND ART

Methods for manufacturing a three-dimensional object via a volumetric 3d-printing process are generally known. Respective volumetric 3d-printing processes particularly, comprise continuously additively manufacturing of at least one three-dimensional object on basis of local polymerization processes of a polymerizable material which typically contains a photoinitiator. Concrete examples of respective volumetric 3d-printing processes comprise multi-color photopolymerization processes, particularly dual-color photopolymerization processes, multi-photon photopolymerization processes, or computed axial lithography, CAL, processes, for instance.

Respective volumetric 3d-printing processes typically comprise light absorption through respective photoinitiators to form photoinitiator radicals e.g. by homolytic bond cleavage or by a reaction with a co-initiator. The reaction with a co-initiator can be by 1^{st} photo-redox reaction+2^{nd} proton transfer, or by H-abstraction forming a photoinitiator fragment or photoinitiator radical, for instance. The photoinitiator can also undergo other reactions such as e.g. a disproportionation or a rearrangement after the light absorption or a radical formation to form another photoinitiator fragment or photoinitiator radical.

In either case, a respective photoinitiator fragment or photoinitiator radical can react with a monomer, a radical chain end, a co-initiator radical, or another photoinitiator fragment or photoinitiator radical in accordance with common radical reactions principles.

The light used in 3d-printing processes for effecting the photopolymerization of a photopolymerizable material, typically has a wavelength above 300 nm, particularly above 350 nm, more particularly above 375 nm, more particularly above 400 nm, which means that the photoinitiator contained in the photopolymerizable material has to absorb light at least somewhere around the UV-visible wavelength border of 400 nm. Given that the photoinitiator has to absorb light of a wavelength in the visible wavelength range during respective volumetric 3d-printing processes, the photoinitiator has to be a chromophore. However, also respective photoinitiator fragments or photoinitiator radicals can be chromophores or form chromophores in a subsequent reaction, such as a disproportionation, a rearrangement or the reaction with a monomer, a radical chain end, a co-initiator radical or another photoinitiator fragment or photoinitiator radical, for instance.

It is generally difficult to remove respective chromophores from the inside of a printed three-dimensional object in volumetric 3d-printing processes. As an example, when a photoinitiator fragment or photoinitiator radical initiates a polymerization or reacts with a radical chain end, the resulting chromophore is bound to the polymer structure of the printed three-dimensional object and cannot be removed e.g. by extraction or washing.

Below illustrated is an example of a way of how a photoinitiator radical, PIH·, and a co-initiator radical, CI·, can be formed from a photoinitiator, PI, and a co-initiator CIH:

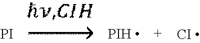

Below illustrated is an example of how a co-initiator fragment, CI, and a photoinitiator, PI, can form part of an exemplary acrylate polymer structure on basis of a radical reaction:

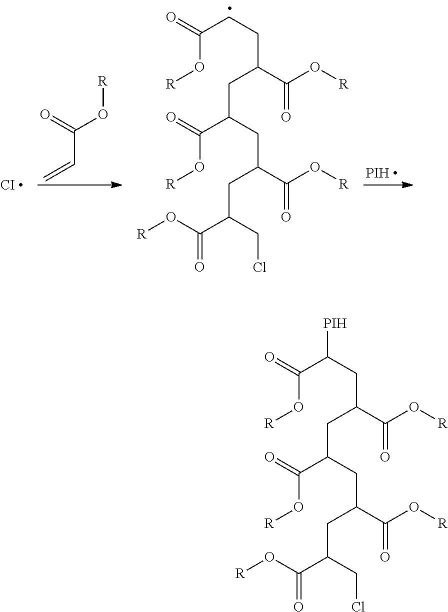

As a consequence, three-dimensional objects manufactured with volumetric 3d-printing processes typically have specific optical properties, namely absorption properties in the visible wavelength range, which result in a color or coloring, respectively of the three-dimensional objects is not always desired and can indeed even be undesired for certain applications.

As such, there is a need to improve methods for manufacturing three-dimensional objects with respect to the optical properties of the three-dimensional objects which can be manufactured therewith.

It is therefore, the object of the invention to overcome the drawbacks of known methods and provide a method which comprises manufacturing a three-dimensional object via a volumetric 3d-printing process which method enables manufacturing a three-dimensional object with improved optical properties.

### SUMMARY OF THE INVENTION

A first aspect of the invention relates to a method for manufacturing a three-dimensional object. The method comprises a first step (step a)) which comprises a volumetric 3d-printing process in which a photopolymerizable material is irradiated with light of at least one wavelength for photopolymerizing the photopolymerizable material to form a three-dimensional object, the three-dimensional object manufactured in accordance with the volumetric 3d-printing process has specific optical properties; and a second step (step b)), following the first step, which second step comprises conducting at least one measure to modify the optical properties of the three-dimensional object.

The volumetric 3d-printing process which is conducted as the first step can generally be or comprise any volumetric 3d-printing process which enables a continuous manufacture of a three-dimensional object. Particularly, the volumetric 3d-printing process which is conducted as the first step can comprise at least one local polymerization process of a polymerizable material, particularly a photopolymerizable material, more particularly a photopolymerizable monomer resin, for the continuous additive manufacture of at least one three-dimensional object. Concrete, yet non-binding examples of a polymerizable material may include acrylates, methacrylates, thiol+ene, epoxides, oxiranes, oxetanes, or vinylethers, and/or a photopolymerizable oligomer resin, which may include but are not limited to acrylates, methacrylates, thiol+ene, epoxides, oxiranes, oxetanes, or vinylethers, for instance. The photopolymerizable material typically, also includes at least one photoinitiator, e.g. a naphthopyran-based or spiropyran-based photoinitiator. The photopolymerizable material can also include at least one co-initiator, e.g. an amine-based co-initiator.

Respective local polymerization processes can comprise irradiating the at least one photoinitiator of the photopolymerizable material with light of at least one wavelength to convert the molecules of the at least one photoinitiator via optical excitation, particularly sequential optical excitation, into a reactive state in which the molecules of the at least one photoinitiator locally trigger a polymerization reaction of the polymerizable material in a working volume of a volumetric 3d-printing apparatus used for performing the volumetric 3d-printing process of the first step. Particularly, photopolymerization of the polymerizable material can be effected inside a working volume of a respective volumetric 3d-printing apparatus by irradiating light of at least one first wavelength and light of at least one further wavelength, which further wavelength is different from the first wavelength, into the working volume of the volumetric 3d-printing apparatus, which results in that the molecules of the at least one photoinitiator are converted, e.g., due to the absorption of light of the first wavelength, from an initial state in which the molecules of the at least one photoinitiator (substantially) do not absorb the light of the further wavelength, into an intermediate state in which the molecules of the at least one photoinitiator absorb the light of the further wavelength which results in that the molecules of the at least one photoinitiator are transferred from the intermediate state to the reactive state which locally triggers the polymerization of the photopolymerizable material to continuously manufacture at least one three-dimensional object inside the working volume of the volumetric 3d-printing apparatus. A back reaction of the molecules of the at least one photoinitiator from the intermediate state into the initial state can be thermally induced, for instance.

Particularly, the volumetric 3d-printing process can comprise irradiating the photopolymerizable material with light of the at least one wavelength in a working volume, wherein the working volume is moved relative to a radiation device of a volumetric 3d-printing apparatus, the radiation device emitting the light of the at least one wavelength during the volumetric 3d-printing process. As such, the volumetric 3d-printing process can be a process in which the working volume is moved relative to a radiation device emitting the light of the at least one wavelength during the volumetric 3d-printing process. A respective motion of the working volume can be a translation motion along a translation axis, as implemented in so-called xolography processes, and/or a rotational motion about a rotational axis, as implemented in computed axial lithography, CAL, processes, for instance.

Notably, the volumetric 3d-printing process which is conducted as the first step can be or comprise a volumetric 3d-printing process denoted as xolography which is specified in WO 2020/245456 A1, the contents of which are incorporated herein by reference.

Alternatively or alternatively, the volumetric 3d-printing process can comprise irradiating the photopolymerizable material with light of the at least one wavelength in a working volume, wherein the working volume is not moved relative to a radiation device of a volumetric 3d-printing apparatus, the radiation device emitting the light of the at least one wavelength during the volumetric 3d-printing process. As such, the volumetric 3d-printing process can be a process in which the working volume is not moved relative to a radiation device emitting the light of the at least one wavelength during the volumetric 3d-printing process.

Particularly, the volumetric 3d-printing process can be a process in which one or more radiation devices are arranged on at least one support structure, wherein the at least one support structure is moveable relative to the working volume, which comprises the photopolymerizable material, in a first degree of freedom of motion, particularly in a plane above the working volume. Particularly, the one or more radiation devices can also be moveable supported relative to the at least one support structure, particularly in a second degree of freedom of motion different from the first degree of freedom of motion. As an example, a respective first degree of freedom of motion can comprise a translatory motion in a first motion direction and a respective second degree of freedom of motion can comprise a second translatory motion in a second motion direction different from the first motion direction, particularly transverse to the first motion direction. Notably, a plurality of respective support structures can be provided, wherein each support structure supports at least one radiation device.

Generally, the volumetric 3d-printing process can comprise irradiating a working volume comprising the photopolymerizable material with light of a specific wavelength, which can comprise the first or further wavelength, from at least two different directions with a specific intensity or intensity distribution, respectively, wherein a polymerization of the photopolymerizable material occurs according to the resulting intensity distribution within the working volume. Irradiating the photopolymerizable material from the at least two different directions can be achieved by at least one of: motion of the working volume relative to at least one (static) radiation device emitting the light of the specific wavelength and/or motion of at least one radiation device emitting the light of the specific wavelength relative to the (static) working volume. As such, the working volume and/or the radiation device can be moveably supported in at least one degree of freedom of motion which can be or comprise a translatory and/or rotatory degree of freedom of motion. In either case, irradiating the photopolymerizable material can be effected simultaneously or sequentially with moving the working volume relative to the at least one radiation device. Typically, the resulting intensity distribution within the working volume largely depends from the intensity of the light, the irradiation direction, the irradiation location, and the absorption properties of the photopolymerizable material and the photopolymerized material, respectively.

As such, the volumetric 3d-printing process can comprise irradiating the photopolymerizable material with light of at least one wavelength emitted from at least two directions, i.e. a first and a second direction, via one radiation device source, particularly one single radiation device. As an example, the first and second directions can be orthogonal directions. As an example, the first direction can impinge on the surface of the photopolymerizable material at a first angle and the second direction can impinge on the surface of the photopolymerizable material at a second angle, which can be different from the first angle. As an example, the light emitted in/from the first direction can at least partially overlap with the light emitted in/from the second direction. Particularly, the (continuous) irradiation of the photopolymerizable material from at least two directions can result in generating portions of high intensity, particularly portions of high intensity in which the photopolymerizable material cures.

Additionally or alternatively, the volumetric 3d-printing process can comprise that the photopolymerizable material is moved, particularly relative a radiation device, before, and/or during, and/or after irradiation with light of the at least one wavelength. As an example, the resin can be provided on a moveably supported conveying element, such as a conveyor band, for instance.

Alternatively or alternatively, the volumetric 3d-printing process can comprise irradiating the photopolymerizable material with light of the at least one wavelength in a working volume, wherein the working volume is moved relative to a radiation device of a volumetric 3d-printing apparatus, the radiation device emitting the light of the at least one wavelength during the volumetric 3d-printing process. As such, the volumetric 3d-printing process can be a process in which the working volume is moved relative to a radiation device emitting the light of the at least one wavelength during the volumetric 3d-printing process.

As such, the volumetric 3d-printing process which is conducted as the first step can also be or comprise a volumetric 3d-printing process oftentimes denoted as Computed Axial Lithography, CAL, as disclosed in documents WO 2018/208378 A2 and Kelly et al.: “Computed Axial Lithography (CAL): Toward Single Step 3D Printing of Arbitrary Geometries” which is available for download from the following URL: https://doi.org/10.48550/arXiv.1705.05893, for instance; or a volumetric 3d-printing process oftentimes denoted as volumetric additive manufacturing via tomographic back-projections or tomographic reconstruction, as disclosed in document Kelly et al. Science, 2019, 363, 1075-1079: “Volumetric additive manufacturing via tomographic reconstruction” which is available for download from the following URL: https://www.science.org/doi/10.1126/science.aau7114, for instance; or in document Loterie et al.: “Volumetric 3D printing of elastomers by tomographic back-projections” which is available for download from the following URL: http://dx.doi.org/10.13140/RG.2.2.20027.46889, for instance. The contents of the aforementioned documents are incorporated herein by reference.

As a concrete example, the volumetric 3d-printing process which is conducted as the first step can thus be or comprise a multi-color photopolymerization process, particularly a dual-color photopolymerization process, a multi-photon photopolymerization process, or a computed axial lithography, CAL, process, or a tomographic reproduction or a tomographic back projection process, for instance.

As will be apparent from further below, the photopolymerizable material can be arranged, e.g. via deposition, on a substrate and then irradiated on the substrate to form at least one three-dimensional object, such as. e.g. a structure, on the substrate.

In either case, the three-dimensional object which has been manufactured in the first step has specific optical properties. Particularly, the optical properties of the three-dimensional object which has been manufactured in the first step refer to the absorption properties of the three-dimensional object in the visible wavelength range (375 nm-800 nm). Hence, the optical properties of the three-dimensional object can relate to a specific color or coloring, respectively of the three-dimensional object in the visible wavelength range. Generally, the concrete color or coloring, respectively of the three-dimensional object depends on the concrete chemical configuration and the related optical properties in the visible wavelength range, particularly the absorption properties in the visible wavelength range, of the chromophores used for printing of the three-dimensional object and/or the chromophores contained within the three-dimensional object. Oftentimes, the optical properties of the three-dimensional object result in that the three-dimensional object has a yellow(ish) color or coloring, respectively. This particularly, applies when the polymerizable material used in the volumetric 3d-printing process comprises a naphthopyran derivative or naphthopyran-based photoinitiators or spiropyran-based photoinitiators, i.e. photoinitiators of the spiropyran/merocyanine system in which the spiropyran form is the thermodynamically preferred form which undergoes a ring-opening reaction upon irradiation with light of a first wavelength which results in that the spiropyran form is transferred in the metastable merocyanine form which can be transferred, particularly by absorption of light of a further wavelength, into the reactive state.

As indicated above, the method comprises a second step of conducting at least one measure to modify the optical properties of the three-dimensional object. The method thus comprises a separate step of conducting at least one measure to modify the optical properties of the three-dimensional object after the first step in which a three-dimensional object has been printed. The method therefore, enables deliberately modifying the optical properties, particularly the absorption properties, of the three-dimensional object which result from the volumetric 3d-printing process in the visible wavelength range. As such, a three-dimensional object can generally be provided with modified optical properties, particularly modified absorption properties, after completion of the first step.

As an example, a three-dimensional object can initially have a first color or coloring, respectively resulting from the volumetric 3d-printing process and is transparent, i.e. has no color or coloring, respectively after completion of the second step. Particularly, the resulting optical properties, particularly the resulting absorption properties, of the three-dimensional object after completion of the second step may result in that the three-dimensional object is transparent in the visible wavelength range. Hence, the three-dimensional object can show no or only little absorption in the visible wavelength range after completion of the second step. Transparency in the visible wavelength range typically means that the transmission of the three-dimensional object in the visible wavelength range is above 80% or absorbance of the three-dimensional object in the visible wavelength range is below 0.5, particularly below 0.3, respectively.

For an exemplary measurement of an absorption or transmission spectrum a rectangular plate is printed, which has a thickness of 1 mm, while the width and height of the plate extent the dimensions of the measurement light beam of the employed spectrometer. The printed plate is placed in the light path of the spectrometer with the flat side of the plate oriented in a perpendicular orientation with respect to the direction of the measurement light beam. In such a setup, the optical path length for which the specific property is measured is 1 mm. A typical measurement may be an absorption spectrum. Initially a background spectrum without the printed plate can be measured and used as a baseline to remove all background artifacts, which do not belong to the sample. Since the recorded spectrum including the printed plate (apparent absorption spectrum) mainly comprises absorption and scattering, the scattering can be removed from the spectrum in a simplified method. The apparent absorption in a wavelength region where the absorption of the plate is neglectable e.g. 750 nm-800 nm is averaged and the so obtained scattering value can be subtracted from the recorded spectrum which results in an absorption spectrum. The absorption spectrum may be used to calculate the transmission spectrum using the formula T=10^{-A}, wherein A is the absorbance and T is the transmittance. Within this application all values for absorption and/or transmission refer to a path length of 1 mm in an experiment as outlined above unless otherwise noted. The terms “absorbance” and “absorption” may be equivalently used in this disclosure. Likewise, the terms “transmittance” and “transmission” may be equivalently used in this disclosure.

Exemplary embodiments consider the Beer-Lambert law for determining the absorbance. According to the Beer-Lambert law the absorbance is proportional to the concentration of a dye or chromophore, respectively, meaning that a reduction of the absorbance at a wavelength where only the dye or chromophore, respectively absorbs, implies that the concentration of the dye or chromophore, respectively has been reduced by the same factor. Furthermore, according to the Beer-Lambert law the absorbance is proportional to the optical path length of the respective measurement, meaning that all values given for 1 mm can be simply transferred to respective values for smaller or larger objects by multiplication with the optical path length in mm which has been used for the measurement of the smaller or larger object.

Particularly, transparency in the visible wavelength range typically means that the transmission of the three-dimensional object in the visible wavelength range is above 80% or the absorbance of the three-dimensional object in the visible wavelength range is below 0.5, particularly below 0.3. The absorption and/or transmission of the three-dimensional object can be determined/measured with a UV-Vis-NIR spectrophotometer of the type “Cary 50” available from Agilent Technologies, Inc., for instance.

Particularly, the at least one measure of conducting at least one measure to modify the optical properties of the three-dimensional object can comprise modifying the optical properties of the three-dimensional object resulting in an absorption per mm of thickness of the three-dimensional object of less than 0.5, particularly less than 0.3, more particularly less than 0.2, more particularly less than 0.1, for at least one wavelength in a wavelength range between 300 nm and 2000 nm, particularly 350 nm and 900 nm.

Particularly, the absorption per mm of thickness of the three-dimensional object is less than 0.5, particularly less than 0.3, more particularly less than 0.2, more particularly less than 0.1, for each wavelength in the wavelength range between 300 nm and 2000 nm, particularly 350 nm and 900 nm.

Particularly, the at least one measure of conducting at least one measure to modify the optical properties of the three-dimensional object can comprise modifying the optical properties of the three-dimensional object resulting in that an average transmission or an integral of the transmission between 300 nm and 2000 nm, particularly 350 nm and 900 nm, more particularly 400 nm and 800 nm, is increased by at least 1%, particularly at least 2%, more particularly at least 3%, more particularly at least 4%, more particularly at least 5%, more particularly at least 7.5%, more particularly at least 10%, more particularly at least 15%, more particularly at least 20%, more particularly at least 25%, more particularly at least 30%, more particularly at least 35%, more particularly at least 40%, more particularly at least 40%, more particularly at least 60%, more particularly at least 80%, more particularly at least 90%, particularly relative to a state of the three-dimensional object before it has undergone the at least one measure.

Particularly, the at least one measure of conducting at least one measure to modify the optical properties of the three-dimensional object can comprise modifying the optical properties of the three-dimensional object resulting in that an average absorption or an integral of the absorption between 300 nm and 2000 nm, particularly 350 nm and 900 nm, more particularly 400 nm and 800 nm, is decreased by at least 1%, particularly at least 2%, more particularly at least 3%, more particularly at least 4%, more particularly at least 5%, more particularly at least 7.5%, more particularly at least 10%, more particularly at least 15%, more particularly at least 20%, more particularly at least 25%, more particularly at least 30%, more particularly at least 35%, more particularly at least 40%, more particularly at least 40%, more particularly at least 60%, more particularly at least 80%, more particularly at least 90%, particularly relative to a state of the three-dimensional object before it has undergone the at least one measure. Alternatively, a three-dimensional object can initially have a first color or coloring, respectively resulting from the volumetric 3d-printing process and have a second color or coloring, respectively, the second color or coloring, respectively having a reduced absorption in the visible wavelength range relative to the first color or coloring, respectively, after completion of the second step. Hence, the three-dimensional object can show reduced absorption in the visible wavelength range after completion of the second step as compared to its absorption in the visible wavelength range after completion of the first step.

The second step is conducted when the first step has been completed. Completion of the first step, i.e. completion of the 3d-printing process of a three-dimensional object is typically, given when no further photopolymerization is effected in the working volume of a respective volumetric 3d-printing apparatus by irradiating the photopolymerizable material in the working volume of the volumetric 3d-printing apparatus with at least one radiation device of the volumetric 3d-printing apparatus for forming the three-dimensional object or a green state of the three-dimensional object. Particularly, completion of the 3d-printing process of a three-dimensional object is given when the printed three-dimensional object has a pre-defined geometric configuration, particularly a pre-defined shape, or the green state of the three-dimensional object has a pre-defined shape. A respective green state typically, represents the pre-defined geometric configuration, i.e. all geometric features and the base shape, of the three-dimensional object, however the green state can have different dimensions and a lower degree of polymerization than the final three-dimensional object. As such, after completion of the first step, the printed three-dimensional object can still be disposed in the working volume of the volumetric 3d-printing apparatus in which it has been printed. Hence, as will be apparent from further below, the second step can be conducted when the three-dimensional object which has been printed in the first step is still within the working volume of the volumetric 3d-printing apparatus used for carrying out the first step.

The provision of a respective second step and the combination of the first and second step results in that an improved method is given which enables manufacturing a three-dimensional object with improved optical properties.

The at least one measure to modify the optical properties of the three-dimensional object can comprise modifying the optical properties of the three-dimensional object such that the absorption of the three-dimensional object is decreased for at least one wavelength in a wavelength range between 300 nm and 2000 nm, particularly in a wavelength range between 350 nm and 1750 nm, more particularly in a wavelength range between 350 nm and 1500 nm, more particularly in a wavelength range between 350 nm and 1250 nm, more particularly in a wavelength range between 350 nm and 1000 nm, more particularly in a wavelength range between 375 nm and 900 nm, more particularly in a wavelength range between 400 nm and 800 nm, such that the transmissive properties of the three-dimensional object are increased for at least one wavelength in the wavelength range between 300 nm and 2000 nm, particularly in the wavelength range between 350 nm and 900 nm. As such, the second step can result in a decrease of the absorption properties of the three-dimensional object for at least one wavelength in a wavelength range between 300 nm and 2000 nm, particularly in a wavelength range between 350 nm and 1750 nm, more particularly in a wavelength range between 350 nm and 1500 nm, more particularly in a wavelength range between 350 nm and 1250 nm, more particularly in a wavelength range between 350 nm and 1000 nm, more particularly in a wavelength range between 375 nm and 900 nm, more particularly in a wavelength range between 400 nm and 800 nm, and in an increase of the transmissive properties of the three-dimensional object for at least one wavelength in the wavelength range between 300 nm and 2000 nm, particularly in a wavelength range between 350 nm and 1750 nm, more particularly in a wavelength range between 350 nm and 1500 nm, more particularly in a wavelength range between 350 nm and 1250 nm, more particularly in a wavelength range between 350 nm and 1000 nm, more particularly in a wavelength range between 375 nm and 900 nm, more particularly in a wavelength range between 400 nm and 800 nm. As indicated above, conducting the second step of the method can particularly, comprise modifying the absorption properties of the three-dimensional object such that the three-dimensional object is transparent in the visible wavelength range. As also indicated above, a three-dimensional object which has a specific color or coloring, respectively after completion of the first step can be colorless after completion of the second step.

The at least one measure to modify the optical properties of the three-dimensional object can comprise a thermal treatment of the three-dimensional object which thermal treatment comprises tempering the three-dimensional object at at least one specific temperature for a specific time. The thermal treatment can particularly, be beneficial since it allows for a high penetration depth into the three-dimensional object such that the above explained principles of changing the transmission or absorption of the three-dimensional can be easily achieved homogeneously and simultaneously through the entire volume of the three-dimensional object. Further, the thermal treatment can result in that inner tensions of the three-dimensional object can at least be reduced. The thermal treatment particularly, comprises optically modifying the optical properties of a three-dimensional object by tempering the three-dimensional object at at least one specific temperature for a specific time. Particularly, thermally modifying the optical properties of the three-dimensional object can comprise thermally altering and/or degrading chromophores in the three-dimensional object and/or thermally generating reactive species in the three-dimensional object which alter and/or degrade chromophores in the three-dimensional object based on tempering the three-dimensional object for a specific time. As such, the three-dimensional object can be subject to a thermal treatment which thermal treatment comprises tempering the three-dimensional object at at least one specific temperature for a specific time (“tempering time”) after completion of the first step. The concrete parameters for tempering the three-dimensional object, i.e. particularly the at least one specific temperature and the specific time, will typically be chosen under consideration of at least one chemical parameter of the three-dimensional object and/or at least one physical parameter of the three-dimensional object. A respective chemical parameter can be the chemical composition of the three-dimensional object, particularly the chemical composition of the chromophores of the three-dimensional object, for instance. A respective physical parameter can be at least one of an optical property, e.g. color, a surface property, a geometric property, e.g. dimensions, shape, volume, etc. of the three-dimensional object, for instance. Particularly, chemical and/or physical parameters affecting the penetration of thermal energy into the three-dimensional object are considered for choosing concrete parameters for tempering the three-dimensional object such that a complete penetration of thermal energy into the three-dimensional object is possible resulting in that the optical properties of the three-dimensional object can be changed throughout the entire volume. However, it is also conceivable that only a partial penetration of thermal energy into the three-dimensional object is desired. In such cases, concrete parameters for tempering the three-dimensional object are chosen such that only a partial penetration of thermal energy into the three-dimensional object is achieved. A partial penetration of thermal energy into the three-dimensional object can generally mean that thermal energy only penetrates into surface regions of the three-dimensional object. Respective penetration depths can comprise depths ranging between 10 μm and 500 μm, particularly between 10 μm and 250 μm, more particularly between 10 μm and 100 μm, from the freely exposed surface of the three-dimensional object, for instance.

Tempering can comprise heating the three-dimensional object at a specific heating temperature for a specific time. Heating the three-dimensional object can result in that the structure of chromophores of the three-dimensional object is altered and/or degraded. Respective chromophores of the three-dimensional object can e.g. comprise residual chromophore photoinitiator molecules, residual co-initiator molecules, photopolymerized polymer resin, etc. Additionally or alternatively, heating the three-dimensional object can result in that a reactive chemical species is generated which reacts with the chromophores such that the structure of the chromophores of the three-dimensional object is altered and/or degraded. Altering the structure of chromophores of the three-dimensional object can be based on a thermally induced chemical reaction of the chromophores and/or a thermally induced rearrangement of parts, e.g. moieties, of the chromophores, for instance. Degrading the structure of chromophores of the three-dimensional object can be based on a thermally induced chemical and/or physical degradation reaction of the chromophores, for instance. Both alteration and/or degradation of the chromophores results in different optical properties of the three-dimensional object. As such, the color or coloring, respectively which a three-dimensional object has after completion of the first step can be changed or removed via a respective thermal treatment such that, after completion of the second step, the three-dimensional object has higher transmittance and/or lower absorbance which results in less color or coloring, respectively or no color or coloring, respectively.

Exemplary temperatures can range between 30° C. to 1000° C., particularly between 40° C. and 500° C., more particularly between 50° C. and 200° C., more particularly between 60° C. and 150°, more particularly between 70° C. and 120° C. As noted above, concrete parameters typically, depend on at least one chemical parameter of the three-dimensional object and/or at least one physical parameter of the three-dimensional object. Also, the tempering times will be considered for choosing a suitable temperature or temperature range, respectively.

Tempering of the three-dimensional object can also comprise subjecting the three-dimensional object at varying temperatures for a specific time. As an example, the three-dimensional object can be subject to increasing temperatures and/or decreasing temperatures for a specific time. As such, the three-dimensional object can be subjected to temperature profiles comprising different stages, such as e.g. heating stages in which the temperature is increased from a lower value to at least one higher value (positive temperature ramp) for a specific time, and/or stationary stages in which the temperature is kept (essentially) constant for a specific time; and/or cooling stages in which the temperature is decreased from a higher value to at least one lower value for a specific time (negative temperature ramp).

Exemplary tempering times can range between 0.5 min and 5 days, particularly between 1 min and 1 day, more particularly between 1 min and 24 h, more particularly between 5 min and 12 h, more particularly between 10 min and 4 h, more particularly between 15 min and 3 h, more particularly between 15 min and 2 h, more particularly between 15 min and 1 h, more particularly between 15 min and 45 min, more particularly between 15 min and 30 min. As noted above, concrete parameters typically, depend on at least one chemical parameter of the three-dimensional object and/or at least one physical parameter of the three-dimensional object. Also, the temperatures or temperature ranges, respectively will be considered for choosing a suitable tempering time.

A respective thermal treatment can be effected when the three-dimensional object is disposed within the working volume in which it has been printed or when the three-dimensional object has been removed from the working volume in which it has been printed. In the latter case, it is conceivable that the three-dimensional object undergoes at least one cleaning step in which residual photopolymerizable material is removed from the surface of the three-dimensional object, before the thermal treatment is initiated.

A respective thermal treatment can be conducted with a thermal treatment device. A respective thermal treatment device can comprise at least one chamber configured for receiving a three-dimensional object to be tempered. The at least one chamber can comprise one or more walls delimiting a chamber interior space. The chamber interior space can be accessible through at least one opening. The at least one opening can have a closure element assigned thereto, the closure element being transferrable, particularly moveable, in a first state (open state) in which it provides access into the chamber interior space, and in a second state (closed state) in which it does not provide access into the chamber interior space.

The at least one chamber can comprise at least one support or suspension structure, e.g. a support plate, a suspension bracket, etc., for supporting or suspending, e.g. in a hanging arrangement, a three-dimensional object in the at least one chamber. Suspending a three-dimensional object can comprise a hanging arrangement of the three-dimensional object. The at least one support or suspension structure can be arranged in the chamber interior space. The at least one support or suspension structure can be moveably supported in at least one degree of freedom of motion, such as e.g. a translational degree of freedom of motion along at least one translation axis and/or a rotational degree of freedom of motion about at least one rotational axis. As a concrete example, the at least one support or suspension structure can be built as or comprise a rotating plate, a rotating suspension bracket, etc. To effect respective motions of the at least one support or suspension structure in the at least one degree of freedom of motion, an actuator device, such as e.g. an electric motor, can be assigned to the at least one support or suspension structure. The at least one support or suspension structure can be provided with one or more fixing elements configured to fix at least one three-dimensional object supported or suspended via the at least one support or suspension structure at the at least one support or suspension structure. As such, it is assured that the three-dimensional object can be kept in position during motions of the at least one support or suspension structure. Respective fixing elements can be or comprise mechanical fixing elements, such as e.g. clamping elements, and/or magnetic fixing elements, such as e.g. permanent magnets or electromagnets, and/or pneumatic fixing elements, such as e.g. suction elements, for instance.

The thermal treatment device can further comprise at least one tempering unit configured for heating the at least one chamber, particularly the chamber interior space, to at least one temperature. The at least one tempering unit can particularly, be configured to dynamically adjust the temperature in the at least one chamber. The at least one tempering unit can particularly, be configured to effect specific temperature profiles, e.g. including stationary temperature stages, positive temperature ramps, negative temperature ramps, temperature plateaus, etc., in the at least one chamber. The at least one tempering unit can be associated with at least one temperature sensor assigned to the at least one chamber which enables a control of the temperature, particularly the implementation of closed-loop control of the temperature, in the at least one chamber.

The thermal treatment device can also comprise a fluid supply unit, particularly a gas supply unit, connectable or connected with the at least one chamber which enables that the at least one chamber, particularly the chamber interior space, can be filled with at least one fluid, particularly at least one gas. A respective liquid or gas can be a reactive liquid or gas such as e.g. an oxidizing and/or reducing liquid or gas which enables that an oxidizing and/or reducing atmosphere can be created in the at least one chamber. Concrete examples of a respective liquid or gas can be argon, nitrogen, oxygen, ozone, hydrogen, chlorine, chlorine compounds, or a gas mixture of argon, nitrogen, oxygen, ozone, hydrogen, chlorine, chlorine compounds, for instance. The at least one fluid supply unit can be associated with at least one fluid sensor assigned to the at least one chamber which enables a control of the atmosphere, particularly the implementation of closed-loop control of the atmosphere, in the at least one chamber. As such, tempering a three-dimensional object can be performed under specific atmospheric conditions.

The thermal treatment device can also comprise a pressure generating unit, e.g. a pump unit, configured to control a pressure level in the at least one chamber, particularly in the chamber interior space. A respective pressure level can be a pressure level above or below a standard or reference pressure level which can be 1 bar, for instance. The at least one pressure generating unit can be associated with at least one pressure sensor assigned to the at least one chamber which enables a control of the pressure, particularly the implementation of closed-loop control of the pressure, in the at least one chamber. As such, tempering a three-dimensional object can be performed under specific pressure conditions.

The thermal treatment device can comprise a hardware- and/or software-embodied controller which can control operation of the tempering unit and/or the fluid supply unit and/or the pressure generating unit so as to control temperature and/or atmosphere and/or pressure in the at least one chamber. The controller can particularly, control temperature and/or atmosphere and/or pressure in the at least one chamber based on sensor information provided from respective sensors assigned to the tempering unit and/or the fluid supply unit and/or the pressure generating unit, for instance.

Alternatively or additionally, the at least one thermal treatment device can be associated with at least one sensor, e.g. a camera, configured to detect the optical properties, particularly the absorption properties and/or the transmission properties, of the three-dimensional object inside the chamber interior space before and/or during and/or after tempering. The at least one sensor can be arranged inside or outside the chamber interior space. The at least one sensor can be an optical sensor configured to detect the optical properties, particularly the absorption properties and/or the transmission properties, of the three-dimensional object which is to be tempered before and/or during and/or after tempering. The sensor values generated by the at least one sensor can be input to the controller of the optical treatment device. The controller can be configured to control temperature and/or atmosphere and/or pressure in the at least one chamber based on sensor information provided from the at least one sensor.

Additionally or alternatively to a thermal treatment, the at least one measure to modify the optical properties of the three-dimensional object can comprise an optical treatment of the three-dimensional object which optical treatment comprises irradiating the three-dimensional object with light of at least one wavelength for a specific time with a specific light intensity. The optical treatment of the three-dimensional object can particularly, be beneficial since it does not require that the three-dimensional object is exposed to harsh chemical and/or physical environments which could possibly compromise other properties of the three-dimensional object, such as surface properties, mechanical properties, etc. Experiments have shown that optical treatments are particularly, beneficial for three-dimensional objects made from materials which are prone to irreversible deformation when subjected to high temperature, such as e.g. temperatures above 80° C. The optical treatment can particularly, be suitable for flat three-dimensional objects since these enable a high penetration depth of the light into the three-dimensional object; notably, the penetration depth will typically increase with increased transparency of the three-dimensional object during the course of implementing the second step of the method. The optical treatment particularly, comprises optically modifying the optical properties of a three-dimensional by irradiating the three-dimensional object with light of at least one wavelength for a specific time. Particularly, optically modifying the optical properties of the three-dimensional object can comprise optically altering and/or degrading chromophores in the three-dimensional object and/or optically generating reactive species in the three-dimensional object which alter and/or degrade chromophores in the three-dimensional object based on irradiating the three-dimensional object with light of at least one wavelength for a specific time. As such, the three-dimensional object can be subject to an optical treatment which optical treatment comprises irradiating the three-dimensional object with light of at least one wavelength and/or intensity for a specific time (“irradiation time”) after completion of the first step. The concrete parameters for irradiating the three-dimensional object, i.e. particularly the at least one wavelength and the specific time, will typically be chosen under consideration of at least one chemical parameter of the three-dimensional object and/or at least one physical parameter of the three-dimensional object. The irradiation time typically, depends on the intensity of the light. The intensity of the light can range between 0.0001-100 W/cm², particularly between 0.001-10 W/cm², more particularly between 0.1-3 W/cm², for instance. A respective chemical parameter can be the chemical composition of the three-dimensional object, particularly the chemical composition of the chromophores of the three-dimensional object, for instance. A respective physical parameter can be at least one of an optical property, e.g. color, a surface property, a geometric property, e.g. dimensions, shape, volume, etc. of the three-dimensional object, for instance. Particularly, chemical and/or physical parameters affecting the penetration of light energy into the three-dimensional object are considered for choosing concrete parameters for irradiating the three-dimensional object such that a complete penetration of light energy into the three-dimensional object is possible resulting in that the optical properties of the three-dimensional object can be changed throughout the entire volume. However, it is also conceivable that only a partial penetration of light energy into the three-dimensional object is desired. In such cases, concrete parameters for irradiating the three-dimensional object are chosen such that only a partial penetration of light energy into the three-dimensional object is achieved. A partial penetration of light energy into the three-dimensional object can generally mean that light energy only penetrates into surface regions of the three-dimensional object. Respective penetration depths can comprise depths ranging between 10 μm and 500 μm, particularly between 10 μm and 250 μm, more particularly between 10 μm and 100 μm, from the freely exposed surface of the three-dimensional object, for instance.

Exemplary wavelengths can range between 350 nm and 1000 nm, particularly between 350 nm and 800 nm, more particularly between 400 nm and 500 nm or between 420 nm and 800 nm. As noted above, concrete parameters typically, depend on at least one chemical parameter of the three-dimensional object and/or at least one physical parameter of the three-dimensional object. Also, the irradiation times will be considered for choosing a suitable wavelength or wavelength range, respectively.

Exemplary irradiation times can range between 1 s and 24 h, particularly 1 s and 12 h, more particularly between 1 s and 6 h, more particularly between 1 s and 3 h, more particularly between 0.5 min and 150 min, more particularly between 0.5 min and 120 min, more particularly between 1 min and 90 min, more particularly between 1 min and 60 min, more particularly between 1 min and 45 min, more particularly between 1 min and 30 min. As noted above, concrete parameters typically, depend on at least one chemical parameter of the three-dimensional object and/or at least one physical parameter of the three-dimensional object. Also, the wavelength or wavelength ranges, respectively will be considered for choosing a suitable irradiation time.

Irradiating the three-dimensional object with light of at least one wavelength, which also covers irradiating the three-dimensional object with light of multiple wavelengths, e.g. a spectrum of wavelengths, can result in that the structure of chromophores of the three-dimensional object is altered and/or degraded. Particularly, multiple wavelengths can be used which overlay with the absorption spectrum of the chromophores of the three-dimensional object which are to be altered and/or degraded. Respective chromophores of the three-dimensional object can e.g. comprise residual chromophore photoinitiator molecules, residual co-initiator molecules, photopolymerized polymer resin, etc. Altering the structure of chromophores of the three-dimensional object can be based on a photon induced chemical reaction of the chromophores and/or a photon induced rearrangement of parts, e.g. moieties, of the chromophores, for instance. Degrading the structure of chromophores of the three-dimensional object can be based on a photon induced chemical and/or physical degradation reaction of the chromophores, for instance. Both alteration and/or degradation of the chromophores results in different optical properties of the three-dimensional object. As such, the color or coloring, respectively which a three-dimensional object has after completion of the first step can be changed or removed via a respective optical treatment such that, after completion of the second step, the three-dimensional object has higher transmittance and/or lower absorbance which results in less color or coloring, respectively or no color or coloring, respectively.

A respective optical treatment can be effected when the three-dimensional object is disposed within the working volume in which it has been printed or when the three-dimensional object has been removed from the working volume in which it has been printed. In the latter case, it is conceivable that the three-dimensional object undergoes at least one cleaning step in which residual photopolymerizable material is removed from the surface of the three-dimensional object, before the optical treatment is initiated.

A respective optical treatment can be conducted with an optical treatment device which can comprise at least one irradiation device configured to irradiate a three-dimensional object with light of at least one wavelength for a specific time. The irradiation device can comprise at least one irradiation unit configured to irradiate a three-dimensional object with directed or undirected light of at least one wavelength, particularly at least one directed or undirected light beam of light of at least one wavelength, from at least one irradiation direction. A respective irradiation unit can comprise one or more light sources each configured to generate light of at least one wavelength. Each respective light source can be configured to generate light having a wavelength ranging between 400 nm and 2000 nm, particularly between 400 nm and 900 nm, particularly between 430 nm and 800 nm. Additionally or alternatively, each respective light source can be configured to emit light having a wavelength in the microwave wavelength range, particularly ranging between 780 nm and 1 cm, or in the infrared wavelength range, particularly ranging between 1 mm and 10 cm. Each respective light source can be built as or comprise at least one laser and/or at least one light emitting diode, for instance. It is conceivable that a first light source is configured to generate light of a first wavelength or a first wavelength range and at least one further light source is configured to generate light of at least one further wavelength or wavelength range, respectively which is different from the first wavelength or wavelength range, respectively. It is conceivable that a three-dimensional object is irradiated with light from multiple different directions which can be realized by arranging multiple irradiation units in different orientations and/or positions relative to a three-dimensional object which is to be irradiated, and/or by moving at least one irradiation unit relative to a three-dimensional object which is to be irradiated, and/or by moving a three-dimensional object which is to be irradiated relative to at least one irradiation unit, for instance.

The optical treatment device can comprise at least one chamber for receiving at least one three-dimensional object to be irradiated. The at least one chamber can comprise one or more walls delimiting a chamber interior space. The chamber interior space can be accessible through at least one opening. The at least one opening can have a closure element assigned thereto, the closure element being transferrable, particularly moveable, in a first state (open state) in which it provides access into the chamber interior space, and in a second state (closed state) in which it does not provide access into the chamber interior space.

The at least one chamber can comprise at least one support or suspension structure, e.g. a support plate, for supporting or suspending a three-dimensional object in the at least one chamber. The at least one support or suspension structure can be at least partially transparent at at least one irradiation wavelength. Alternatively, at least one support or suspension structure can be at least partially reflective for at least one irradiation wavelength. The at least one support or suspension structure can be arranged in the chamber interior space. The at least one support or suspension structure can be moveably supported in at least one degree of freedom of motion, such as e.g. a translational degree of freedom of motion along at least one translation axis and/or a rotational degree of freedom of motion about at least one rotational axis. As a concrete example, the at least one support or suspension structure can be built as or comprise a rotating plate. To effect respective motions of the at least one support or suspension structure in the at least one degree of freedom of motion, an actuator device, such as e.g. an electric motor, can be assigned to the at least one support or suspension structure. The at least one support or suspension structure can be provided with one or more fixing elements configured to fix at least one three-dimensional object supported via the at least one support or suspension structure at the at least one support or suspension structure. As such, it is assured that the three-dimensional object can be kept in position during motions of the at least one support or suspension structure. Respective fixing elements can be or comprise mechanical fixing elements, such as e.g. clamping elements, and/or magnetic fixing elements, such as e.g. permanent magnets or electromagnets, and/or pneumatic fixing elements, such as e.g. suction elements, for instance.

The optical treatment device can further comprise at least one tempering unit configured for heating the at least one chamber, particularly the chamber interior space, to at least one temperature. The at least one tempering unit can particularly, be configured to dynamically adjust the temperature in the at least one chamber. The at least one tempering unit can particularly, be configured to effect specific temperature profiles, e.g. including positive temperature ramps, negative temperature ramps, temperature plateaus, etc., in the at least one chamber. The at least one tempering unit can be associated with at least one temperature sensor assigned to the at least one chamber which enables a control of the temperature, particularly the implementation of closed-loop control of the temperature, in the at least one chamber.

The optical treatment device can also comprise a fluid supply unit, particularly a gas supply unit, connectable or connected with the at least one chamber which enables that the at least one chamber, particularly the chamber interior space, can be filled with at least one fluid, particularly at least one gas. A respective liquid or gas can be a reactive liquid or gas such as e.g. an oxidizing and/or reducing liquid or gas which enables that an oxidizing and/or reducing atmosphere can be created in the at least one chamber. Concrete examples of a respective liquid or gas can be argon, nitrogen, oxygen, ozone, hydrogen, chlorine, chlorine compounds, for instance. The at least one fluid supply unit can be associated with at least one fluid sensor assigned to the at least one chamber which enables a control of the atmosphere, particularly the implementation of closed-loop control of the atmosphere, in the at least one chamber. As such, irradiating a three-dimensional object can be performed under specific atmospheric conditions.

The optical treatment device can also comprise a pressure generating unit, e.g. a pump unit, configured to control a pressure level in the at least one chamber, particularly in the chamber interior space. A respective pressure level can be a pressure level above or below a standard or reference pressure level which can be 1 bar, for instance. The at least one pressure generating unit can be associated with at least one pressure sensor assigned to the at least one chamber which enables a control of the pressure, particularly the implementation of closed-loop control of the pressure, in the at least one chamber. As such, irradiating a three-dimensional object can be performed under specific pressure conditions.

The optical treatment device can comprise a hardware- and/or software-embodied controller which can control operation of the irradiation unit and/or the tempering unit and/or the fluid supply unit and/or the pressure generating unit so as to control irradiation parameters and/or temperature and/or atmosphere and/or pressure in the at least one chamber. The controller can particularly, control irradiation parameters and/or temperature and/or atmosphere and/or pressure in the at least one chamber based on sensor information provided from respective sensors assigned to the fluid supply unit and/or the pressure generating unit, for instance.

Alternatively or additionally, the at least one optical treatment device can be associated with at least one sensor, e.g. a camera, configured to detect the optical properties, particularly the absorption properties and/or the transmission properties, of the three-dimensional object inside the chamber interior space before and/or during and/or after irradiating. The at least one sensor can be arranged inside or outside the chamber interior space. The at least one sensor can be an optical sensor configured to detect the optical properties, particularly the absorption properties and/or the transmission properties, of the three-dimensional object which is to be irradiated. The sensor values generated by the at least one sensor can be input to the controller of the optical treatment device. The controller can be configured to control temperature and/or atmosphere and/or pressure in the at least one chamber based on sensor information provided from the at least one sensor.

Additionally or alternatively to a thermal treatment and/or an optical treatment, the at least one measure to modify the optical properties of the three-dimensional object can comprise a chemical treatment of the three-dimensional object with at least one chemical modifying agent. The at least one chemical modifying agent can be a solid, a liquid, or a gas. The chemical treatment particularly, comprises chemically modifying the optical properties of a three-dimensional object by subjecting the three-dimensional object to at least one chemical modifying agent. Particularly, chemically modifying the optical properties of the three-dimensional object can comprise chemically altering and/or degrading chromophores in the three-dimensional object and/or chemically generating reactive species in the three-dimensional object which alter and/or degrade chromophores in the three-dimensional object based on a reaction of the three-dimensional object with the at least one chemical modifying agent. As such, the three-dimensional object can be subject to a chemical treatment which chemical treatment comprises subjecting the three-dimensional object to at least one chemical modifying agent or a mixture, particularly a solution, containing the at least one chemical modifying agent for a specific time (“reaction time”) after completion of the first step. The concrete chemical parameters of the chemical reaction, e.g. type of chemical reaction, between the at least one chemical modifying agent and the three-dimensional object or respective chromophores of the three-dimensional, respectively object will typically be chosen under consideration of at least one chemical parameter of the three-dimensional object and/or at least one physical parameter of the three-dimensional object. A respective chemical parameter can be the chemical composition of the three-dimensional object, particularly the chemical composition of the chromophores of the three-dimensional object, for instance. A respective physical parameter can be at least one of an optical property, e.g. color, a surface property, a geometric property, e.g. dimensions, shape, volume, etc. of the three-dimensional object, for instance. Particularly, chemical and/or physical parameters affecting the reactivity of the three-dimensional object are considered for choosing concrete parameters for the chemical reaction between the at least one chemical modifying agent and the three-dimensional object such that a chemical reaction of the complete three-dimensional object is possible resulting in that the optical properties of the three-dimensional object can be changed throughout the entire volume. However, it is also conceivable that only a partial chemical reaction of the three-dimensional object is desired. In such cases, concrete parameters for the chemical reaction, such as e.g. concentration of the at least one chemical modifying agent, of the three-dimensional object are chosen such that only a partial chemical reaction of the three-dimensional object is achieved. A partial chemical reaction of the three-dimensional object can generally mean that only surface regions of the three-dimensional object react. Respective surface portions can comprise depths ranging between 10 μm and 500 μm, particularly between 10 μm and 250 μm, more particularly between 10 μm and 100 μm, from the freely exposed surface of the three-dimensional object, for instance.

The chemical reaction between the at least one chemical modifying agent and the three-dimensional object can result in that the structure of chromophores of the three-dimensional object is altered and/or degraded. Respective chromophores of the three-dimensional object can e.g. comprise residual chromophore photoinitiator molecules, residual co-initiator molecules, photopolymerized polymer resin, etc. Altering the structure of chromophores of the three-dimensional object can thus be based on a chemical reaction of the at least one chemical modifying agent with the chromophores which can effect a rearrangement of parts, e.g. moieties, of the chromophores, for instance. Degrading the structure of chromophores of the three-dimensional object can be based on a chemical reaction of the at least one chemical modifying agent with the chromophores which can effect a chemical degradation of the chromophores, for instance. Both alteration and/or degradation of the chromophores results in different optical properties of the three-dimensional object. As such, the color or coloring, respectively which a three-dimensional object has after completion of the first step can be changed or removed via a respective chemical treatment such that, after completion of the second step, the three-dimensional object has higher transmittance and/or lower absorbance which results in less color or coloring, respectively or no color or coloring, respectively.

The at least one chemical modifying agent can be configured, i.e. have a chemical structure, to alter the chromophore properties of chromophores, particularly residual photoinitiator molecules, of the photopolymerizable material and/or chromophores resulting from the photopolymerization process. Additionally or alternatively, the at least one chemical modifying agent can be configured, i.e. have a chemical structure, to generate a reactive agent configured to alter the chromophore properties of chromophores, particularly residual photoinitiator molecules, of the photopolymerizable material or photopolymerized material forming the three-dimensional object. Altering the chromophore properties of the chromophores can in either case particularly, comprise degrading chromophore groups of the chromophores. Altering the chromophore properties of the chromophores via the at least one chemical modifying agent can in either case be effected under the influence of energy, particularly thermal energy and/or photon energy.

As an example, the at least one chemical modifying agent can be or comprise at least one of an oxidizing agent, particularly an oxidizing acid, particularly a peroxyacid, or at least one reducing agent, particularly a reducing base, or a salt, particularly a sulfonium-based salt or an iodonium-based salt, configured to alter, particularly degrade, chromophores, particularly residual photoinitiator molecules, of the three-dimensional object.

As an alternate or additional example, the at least one chemical modifying agent can be or comprise a chlorine-based substance, particularly chlorine, hypochlorite, chlorine dioxide, or an oxygen-based substance, particularly ozone, oxygen, peroxide, perborate, percarbonate, peracetic acid.

Exemplary reaction times can range between 1 min and 24 h, more particularly between 5 min and 12 h, more particularly between 10 min and 4 h, more particularly between 15 min and 3 h, more particularly between 15 min and 2 h, more particularly between 15 min and 1 h, more particularly between 15 min and 45 min, more particularly between 15 min and 30 min. As noted above, concrete parameters typically, depend on at least one chemical parameter of the three-dimensional object and/or at least one physical parameter of the three-dimensional object.

A respective chemical treatment can be effected when the three-dimensional object is disposed within the working volume in which it has been printed or when the three-dimensional object has been removed from the working volume in which it has been printed. In the latter case, it is conceivable that the three-dimensional object undergoes at least one cleaning step in which residual photopolymerizable material is removed from the surface of the three-dimensional object, before the chemical treatment is initiated.

It is conceivable that the at least one chemical modifying agent is added to the photopolymerizable material before and/or during formation of the three-dimensional object. Hence, the first step of the method can comprise adding the at least one chemical modifying agent to the photopolymerizable material before and/or during formation of the three-dimensional object. As such, the at least one chemical modifying agent can form part of the three-dimensional object such that, in the second step, the chemical reaction needs only to be initiated by subjecting the three-dimensional object to suitable chemical and/or physical conditions which enable initiating the chemical reaction. As an example, the chemical reaction can be initiated by applying energy, e.g. thermal energy and/or light energy, to the three-dimensional object.

It is also conceivable that the at least one chemical modifying agent is added after forming the three-dimensional object. Hence, the second step may comprise adding at least one chemical modifying agent to the three-dimensional object or the photopolymerized material forming the three-dimensional object after forming the three-dimensional object. As such, the at least one chemical modifying agent does not necessarily have to form part of the three-dimensional object before the second step such that, in the second step, first the at least one chemical modifying agent needs to be added to the three-dimensional object and then the chemical reaction needs to be initiated by subjecting the three-dimensional object to suitable chemical and/or physical conditions which enable initiating the chemical reaction. As an example, the chemical reaction can be initiated by applying energy, e.g. thermal energy and/or light energy, to the three-dimensional object. Alternatively, the chemical reaction can be initiated by means of a chemical initiating agent.

In embodiments in which the at least one chemical modifying agent is added to the photopolymerized material after forming the three-dimensional object, the three-dimensional object can be placed in a solution containing the at least one chemical modifying agent for a specific time. When the three-dimensional object is placed in the solution, the at least one chemical modifying agent can migrate from the solution into the three-dimensional object. Optionally residual co-initiator and/or residual photoinitiator can migrate from the three-dimensional object into the solution. A respective solution can thus comprise at least one solvent, particularly an inert organic solvent, e.g. cyclohexane or ethanol, and the at least one chemical modifying agent. This particularly, applies to embodiments in which the at least one chemical modifying agent is a liquid. A concrete example of a solution can comprise a mixture of 70% ethanol, 10% acetic acid, and 20% aqueous hydrogen peroxide (30% H₂O₂).

In further embodiments in which the at least one chemical modifying agent is added to the photopolymerized material after forming the three-dimensional object, the three-dimensional object can be placed in an atmosphere containing the at least one chemical modifying agent for a specific time, a specific temperature, and a specific pressure, for instance. When the three-dimensional object is placed in the atmosphere, the at least one chemical modifying agent can migrate from the atmosphere into the three-dimensional object. A respective atmosphere thus comprises at least one reactive gas, particularly oxygen and/or ozone and/or hydrogen, chlorine and/or chlorine compounds, such as HCl, for instance.

A respective chemical treatment can be conducted with a chemical treatment device. The chemical treatment device can comprise at least one chamber (reactor) for receiving at least one three-dimensional object. The at least one chamber can comprise one or more walls delimiting a chamber interior space. The chamber interior space can be accessible through at least one opening. The at least one opening can have a closure element assigned thereto, the closure element being transferrable, particularly moveable, in a first state (open state) in which it provides access into the chamber interior space, and in a second state (closed state) in which it does not provide access into the chamber interior space.

The at least one chamber can comprise at least one support or suspension structure, e.g. a support plate, for supporting or suspending a three-dimensional object in the at least one chamber. The at least one support or suspension structure can be arranged in the chamber interior space. The at least one support or suspension structure can be moveably supported in at least one degree of freedom of motion, such as e.g. a translational degree of freedom of motion along at least one translation axis and/or a rotational degree of freedom of motion about at least one rotational axis. As a concrete example, the at least one support or suspension structure can be built as or comprise a rotating plate. To effect respective motions of the at least one support or suspension structure in the at least one degree of freedom of motion, an actuator device, such as e.g. an electric motor, can be assigned to the at least one support or suspension structure. The at least one support or suspension structure can be provided with one or more fixing elements configured to fix at least one three-dimensional object supported via the at least one support or suspension structure at the at least one support or suspension structure. As such, it is assured that the three-dimensional object can be kept in position during motions of the at least one support or suspension structure. Respective fixing elements can be or comprise mechanical fixing elements, such as e.g. clamping elements, and/or magnetic fixing elements, such as e.g. permanent magnets or electromagnets, and/or pneumatic fixing elements, such as e.g. suction elements, for instance.

The chemical treatment device can further comprise at least one tempering unit configured for heating the at least one chamber, particularly the chamber interior space, to at least one temperature. The at least one tempering unit can particularly, be configured to dynamically adjust the temperature in the at least one chamber. The at least one tempering unit can particularly, be configured to effect specific temperature profiles, e.g. including positive temperature ramps, negative temperature ramps, temperature plateaus, etc., in the at least one chamber. The at least one tempering unit can be associated with at least one temperature sensor assigned to the at least one chamber which enables a control of the temperature, particularly the implementation of closed-loop control of the temperature, in the at least one chamber. A respective control of the temperature can be used to enable a control of the kinetics of the reaction between the at least one chemical modifying agent and the three-dimensional object. As such, the chemical reaction of the three-dimensional object can be performed under specific thermal conditions.

The chemical treatment device can also comprise a fluid supply unit, particularly a liquid or gas supply unit, connectable or connected with the at least one chamber which enables that the at least one chamber, particularly the chamber interior space, can be filled with the at least one chemical modifying agent and/or a liquid or gas containing the at least one chemical modifying agent. The at least one fluid supply unit can be associated with at least one fluid sensor assigned to the at least one chamber which enables a control of the concentration of reactants and/or products of the chemical reaction between the at least one chemical modifying agent and the three-dimensional object, particularly the implementation of closed-loop control of the concentration of reactants and/or products of the chemical reaction between the at least one chemical modifying agent and the three-dimensional object, in the at least one chamber. A respective control of the concentration can be used to enable a control of the kinetics of the reaction between the at least one chemical modifying agent and the three-dimensional object.

The chemical treatment device can also comprise a pressure generating unit, e.g. a pump unit, configured to control a pressure level in the at least one chamber, particularly in the chamber interior space. A respective pressure level can be a pressure level above or below a standard or reference pressure level which can be 1 bar, for instance. The at least one pressure generating unit can be associated with at least one pressure sensor assigned to the at least one chamber which enables a control of the pressure, particularly the implementation of closed-loop control of the pressure, in the at least one chamber. A respective control of the pressure can be used to enable a control of the kinetics of the reaction between the at least one chemical modifying agent and the three-dimensional object. As such, the chemical reaction of the three-dimensional object can be performed under specific pressure conditions.

The chemical treatment device can comprise a hardware- and/or software-embodied controller which can control operation of the tempering unit and/or the fluid supply unit and/or the pressure generating unit so as to control temperature parameters and/or atmosphere and/or pressure in the at least one chamber. The controller can particularly, control temperature and/or atmosphere and/or pressure in the at least one chamber based on sensor information provided from respective sensors assigned to the tempering unit and/or the fluid supply unit and/or the pressure generating unit, for instance.

Alternatively or additionally, the at least one chemical treatment device can be associated with at least one sensor, e.g. a camera, configured to detect the optical properties, particularly the absorption properties and/or the transmission properties, of the three-dimensional object inside the chamber interior space before and/or during and/or after the chemical reaction. The at least one sensor can be arranged inside or outside the chamber interior space. The at least one sensor can be an optical sensor configured to detect the optical properties, particularly the absorption properties and/or the transmission properties, of the three-dimensional object. The sensor values generated by the at least one sensor can be input to the controller of the optical treatment device. The controller can be configured to control temperature and/or atmosphere and/or pressure in the at least one chamber based on sensor information provided from the at least one sensor.

As indicated above, the photopolymerizable material can comprise a photopolymerizable polymer resin and a photoinitiator, particularly a naphthopyran derivative or a naphthopyran-based photoinitiator or spiropyran-based photoinitiator, which can be converted, particularly via sequential optical excitation, into a reactive state in which the molecules of the photoinitiator locally trigger a polymerization reaction of the polymerizable polymer resin.

Particularly, the photoinitiator is a spiropyran-based photoinitiator which is a spiropyran comprising at least one carbonyl-group.

Particularly, the photoinitiator can be a spiropyran-based photoinitiator represented by the following exemplary formula (1):

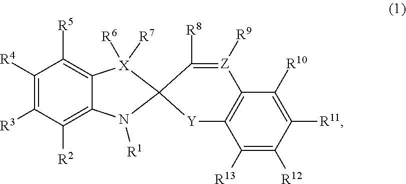

wherein X is selected from S, CR⁶R⁷, or NR⁶; Y is selected from O, S, or N; where Y is N, the substituent contains the atoms necessary to complete a cyclic structure with R¹³ selected from the group consisting of benzimidazole, indoline, indole, dihydroquinoline, and tetrahydroquinoline; wherein Z is selected from N or CR⁹; R¹ to R¹³ can be independently selected from the group consisting of H; D; halogen; NO₂; CN; OH; SH; CF₃; substituted or unsubstituted C₁-C₂₀-alkyl; substituted or unsubstituted C₃-C₂₀-cycloalkyl; substituted or unsubstituted C₆-C₄₈-aryl; substituted or unsubstituted C₂-C₄₂-heteroaryl; substituted or unsubstituted C₂-C₄₉-alkyl acyl; substituted or unsubstituted C₂-C₄₉-aryl acyl; substituted or unsubstituted C₁-C₂₀-alkoxy; substituted or unsubstituted C₆-C₄₈-aryloxy; NH₂; substituted or unsubstituted C₁-C₂₀-alkyl ester; substituted or unsubstituted C₆-C₄₈-aryl ester; substituted or unsubstituted C₁-C₂₀ alkyl amide; substituted or unsubstituted C₆-C₄₈-aryl amide; NR′₂; SiR′₃; —O—SiR′₃, wherein R′ is independently selected from the group consisting of substituted or unsubstituted C₁-C₂₀-alkyl and substituted or unsubstituted C₆-C₄₈-aryl, two R′ may form a ring structure; substituted or unsubstituted carboxylic acids and salts thereof; substituted or unsubstituted sulfonic acids and salts thereof; substituted or unsubstituted sulfonic esters; substituted or unsubstituted sulfonic amides; formyl; ether; thioether; carbonate; carbonate ester; sulfates; boronic acids; boronic esters; phosphonic acids; phosphonic esters; phosphines; phosphates; peroxycarbonic acids; thiocarbonic acids; sulfinic acids; sulfinic esters; sulfonates; thiolesters, sulfoxides; sulfones; alkylsulfones; hydrazides; thioaldehydes; ketones; thioketones; oximes; hydrazines; nitroso; azo; diazo; diazonium; isocyanides; cyanate; isocyanate; thiocyanate; isothiocyanate; hydroperoxide; peroxide; acetals; ketal; orthoester; orthocarbonate esters; ammonium; imines; imides; azide; nitrate; isonitrile; nitrosoxy; substituted or unsubstituted carbamates; substituted or unsubstituted ethers; substituted or unsubstituted polyether carbamates; substituted or unsubstituted arylazo; substituted or unsubstituted C₂-C₂₀-alkynyl and substituted or unsubstituted C₂-C₂₀-alkenyl; wherein two adjacent groups of may be linked to each other to form a fused ring structure, preferably, a fused aromatic C₆-ring; wherein the one or more substituents, if present in one or more of R¹ to R¹³, are independently selected from the group consisting of D; halogen; NO₂; CN, C₂-C₄₉-alkyl acyl; substituted or unsubstituted C₁-C₂₀-alkoxy; substituted or unsubstituted C₆-C₄₈-aryloxy; substituted or unsubstituted C₂-C₄₉-aryl acyl; (meth)acrylate; tosyl; sulfonic acid or salts thereof; carboxylic acid or salts thereof; boronic acid or salts thereof; phosphonic acid or salts thereof; NR′₃⁺, wherein R′ is independently selected from the group consisting of H, D, substituted or unsubstituted C₁-C₂₀-alkyl and substituted or unsubstituted C₆-C₄₈-aryl, two R′ may form a ring structure; NH₂; and OH; wherein if present two adjacent groups of R¹⁰ to R¹³, and R² to R⁵ may be independently linked to each other to form a fused ring structure.

Particularly, at least one of R¹ to R¹³, preferably R² to R⁵ or R¹⁰ to R¹³, more preferably R¹⁰ to R¹³ are substituents selected from the group consisting of carbonyl; chlorine; bromine; iodine; formyl; carbonate; carbonate ester; ester; amide; CF₃; substituted or unsubstituted C₂-C₄₉-alkyl acyl; substituted or unsubstituted C₂-C₄₉-aryl acyl; ketone; acyl; oxime; aldehyde, NO₂; CN; (meth)acrylate; sulfones; alkylsulfones; sulfonamides; SO₂Me; SO₂NH₂; methoxy; and tosyl; or one of the following formulae:

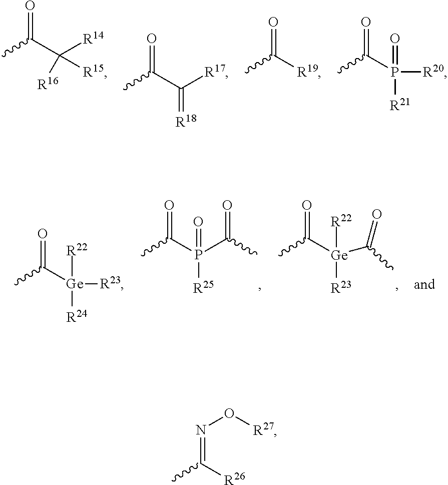

so that the spiropyran contains at least one such substituent.

In a further embodiment, at least one of R¹ to R¹³ may comprise the structural motif of at least one of thioxanthone, acenaphthylene-1,2-dione, thiochroman-4-on, 9-fluorenone, anthraquinone, benzanthrone, 9,10-phenanthrenequinone, xanthone, 1,3-indanedione, chromone, 1,4-naphthoquinone, coumarin, benzil, benzophenone, acetophenone.

In a further embodiment, at least one of R¹ to R¹³ may be substituted or unsubstituted C₆-C₄₈-aryl or substituted or unsubstituted C₁-C₂₀-alkyl, wherein the substituent comprises the structural motif of at least one of thioxanthone, acenaphthylene-1,2-dione, thiochroman-4-on, 9-fluorenone, anthraquinone, benzanthrone, 9,10-phenanthrenequinone, xanthone, 1,3-indanedione, chromone, 1,4-naphthoquinone, coumarin, benzil, benzophenone, acetophenone.

Particularly, R⁴ can be an acceptor, particularly, substituted or unsubstituted alkylacyl, substituted or unsubstituted arylacyl, CF₃, CN, alkylsulfones; sulfonamides, SO₂Me; SO₂NH₂.

Particularly, R¹ may be selected from H, D, substituted or unsubstituted C₁-C₄-alkyl, phenyl and benzyl. More preferred, R¹ is methyl, phenyl or benzyl.

Particularly, X is C and R⁶ and R⁷ may be independently selected from H, D, C₁-C₄-alkyl, or comprise the atoms necessary to form a substituted or unsubstituted C₃-C₂₀-cycloalkyl moiety. More preferably, R¹ and R² are methyl or contain the atoms necessary to form a cyclohexane ring.

Particularly, Z is CH.

Particularly, Y is O.

Particularly, R¹³ can be substituted or unsubstituted alkylacyl, substituted or unsubstituted arylacyl or one of the following exemplary formulae:

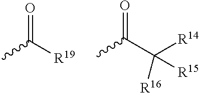

R¹⁴ to R²⁷ can be independently selected from the group consisting of H; D; halogen; NO₂; CN; OH; SH; CF₃; substituted or unsubstituted C₁-C₂₀-alkyl; substituted or unsubstituted C₃-C₂₀-cycloalkyl; substituted or unsubstituted C₆-C₄₈-aryl; substituted or unsubstituted C₂-C₄₂-heteroaryl; substituted or unsubstituted C₂-C₄₉-alkyl acyl; substituted or unsubstituted C₂-C₄₉-aryl acyl; substituted or unsubstituted C₁-C₂₀-alkoxy; substituted or unsubstituted C₆-C₄₈-aryloxy, and NH₂; substituted or unsubstituted C₁-C₂₀-alkyl ester; substituted or unsubstituted C₆-C₄₈-aryl ester; substituted or unsubstituted C₁-C₂₀ alkyl amide; substituted or unsubstituted C₆-C₄₈-aryl amide; NR′₂, SiR′₃, —O—SiR′₃ wherein R′ is independently selected from the group consisting of substituted or unsubstituted C₁-C₂₀-alkyl and substituted or unsubstituted C₆-C₄₈-aryl, two R′ may form a ring structure; substituted or unsubstituted carboxylic acids and salts thereof; substituted or unsubstituted sulfonic acids and salts thereof; substituted or unsubstituted sulfonic esters; substituted or unsubstituted sulfonic amides; formyl; ether, thioether; carbonate; carbonate ester; sulfates; boronic acids; boronic esters; phosphonic acids; phosphonic esters; phosphines; phosphates; peroxycarbonic acids; thiocarbonic acids; sulfinic acids; sulfinic esters; sulfonates; thiolesters, sulfoxides; sulfones; alkylsulfones; hydrazides; thioaldehydes; ketones; thioketones; oximes; hydrazines; nitroso; azo; diazo; diazonium; isocyanides; cyanate; isocyanate; thiocyanate; isothiocyanate; hydroperoxide; peroxide; acetals; ketal; orthoester; orthocarbonate esters; ammonium; imines; imides; azide; nitrate; isonitrile; nitrosoxy; substituted or unsubstituted carbamates; substituted or unsubstituted ethers; substituted or unsubstituted polyether carbamates; substituted or unsubstituted arylazo; substituted or unsubstituted C₂-C₂₀-alkynyl and substituted or unsubstituted C₂-C₂₀-alkenyl; wherein the one or more substituents, if present in one or more of R¹⁴-R²⁷, are independently selected from the group consisting of D; halogen; NO₂; CN, C₂-C₄₉-alkyl acyl; substituted or unsubstituted C₁-C₂₀-alkoxy; substituted or unsubstituted C₆-C₄₈-aryloxy; substituted or unsubstituted C₂-C₄₉-aryl acyl; (meth)acrylate; tosyl; sulfonic acid or salts thereof, carboxylic acid or salts thereof, boronic acid or salts thereof, phosphonic acid or salts thereof, NR′₃⁺, wherein R′ is independently selected from the group consisting of H, D, substituted or unsubstituted C₁-C₂₀-alkyl and substituted or unsubstituted C₆-C₄₈-aryl, two R′ may form a ring structure; NH₂; and OH; and R¹⁵ and R¹⁶ may be linked to each other to form a unsubstituted or substituted ring structure.

Preferably, R¹⁴ may be selected from H, methyl, halogen, more preferably R¹⁴, R¹⁵, and R¹⁶ may be independently selected from H, methyl, halogen. More preferably R¹⁴, R¹⁵, and R¹⁶ are chlorine.

Preferably, R¹⁴, R¹⁵, and R¹⁶ may be independently selected from H, D, CN, substituted or unsubstituted C₁-C₁₀-alkyl; substituted or unsubstituted C₃-C₁₀-cycloalkyl; substituted or unsubstituted C₆-C₃₂-aryl; substituted or unsubstituted C₂-C₂₈-heteroaryl, more preferably, R¹⁴, R¹⁵, and R¹⁶ may be selected from methyl, phenyl, or substituted phenyl.

In a further exemplary embodiment, R¹⁴ may be NR′₂, wherein R′ may be independently selected from the group consisting of H, D, substituted or unsubstituted C₁-C₁₀-alkyl and substituted or unsubstituted C₆-C₃₂-aryl, and two R′ may form a ring structure; R¹⁵ and R¹⁶ may be independently selected from H, D, CN, substituted or unsubstituted C₁-C₁₀-alkyl; substituted or unsubstituted C₃-C₁₀-cycloalkyl; substituted or unsubstituted C₆-C₃₂-aryl; substituted or unsubstituted C₂-C₂₈-heteroaryl. More preferably, R¹⁴ may be NR′₂, wherein R′ may be independently selected from the group consisting of substituted or unsubstituted C₁-C₁₀-alkyl, two R′ may form a ring structure; R¹⁵ and R¹⁶ may be independently selected from substituted or unsubstituted C₁-C₁₀-alkyl; substituted or unsubstituted C₃-C₁₀-cycloalkyl; substituted or unsubstituted C₆-C₃₂-aryl. Most preferably, R¹⁴ may be NR′₂, wherein R′ may be methyl, ethyl, or two R′ completing a morpholine; R¹⁵ and R¹⁶ are independently selected from methyl, ethyl, and benzyl.

In another exemplary embodiment, R¹⁴ may be OR′, wherein R′ is selected from the group consisting of H, D, substituted or unsubstituted C₁-C₁₀-alkyl; substituted or unsubstituted C₃-C₁₀-cycloalkyl; substituted or unsubstituted C₆-C₃₂-aryl; substituted or unsubstituted C₂-C₂₈-heteroaryl, SiR″₃, wherein R″ is independently selected from the group consisting of substituted or unsubstituted C₁-C₁₀-alkyl and substituted or unsubstituted C₆-C₃₂-aryl, R¹⁵ and R¹⁶ may be independently selected from H, D, CN, substituted or unsubstituted C₁-C₁₀-alkyl; substituted or unsubstituted C₃-C₁₀-cycloalkyl; substituted or unsubstituted C₆-C₃₂-aryl; substituted or unsubstituted C₂-C₂₈-heteroaryl. More preferably, R¹⁴ may be OR′, wherein R′ is independently selected from the group consisting of H, D, substituted or unsubstituted C₁-C₁₀-alkyl, substituted or unsubstituted C₃-C₁₀-cycloalkyl, SiR″₃, wherein R″ is independently selected from the group consisting of substituted or unsubstituted C₁-C₁₀-alkyl and substituted or unsubstituted C₆-C₃₂-aryl. R¹⁵ and R¹⁶ may be independently selected from substituted or unsubstituted C₁-C₁₀-alkyl; substituted or unsubstituted C₃-C₁₀-cycloalkyl; substituted or unsubstituted C₆-C₃₂-aryl. Most preferably, R¹⁴ is OR′, wherein R′ is methyl, ethyl, benzyl, or trimethylsilyl; and R¹⁵ and R¹⁶ are independently selected from methyl, ethyl, phenyl, and benzyl.

In a further exemplary embodiment, R¹⁴ and R¹⁵ may be OR′, wherein R′ is independently selected from the group consisting of H, D, substituted or unsubstituted C₁-C₁₀-alkyl; substituted or unsubstituted C₃-C₁₀-cycloalkyl; substituted or unsubstituted C₆-C₃₂-aryl; substituted or unsubstituted C₂-C₂₈-heteroaryl, R¹⁶ may be selected from H, D, CN, substituted or unsubstituted C₁-C₁₀-alkyl; substituted or unsubstituted C₃-C₁₀-cycloalkyl; substituted or unsubstituted C₆-C₃₂-aryl; substituted or unsubstituted C₂-C₂₈-heteroaryl. More preferably, R¹⁴ and R¹⁵ may be OR′, wherein R′ is independently selected from the group consisting of H, D, substituted or unsubstituted C₁-C₁₀-alkyl, substituted or unsubstituted C₃-C₁₀-cycloalkyl; and R¹⁶ may be selected from substituted or unsubstituted C₁-C₁₀-alkyl; substituted or unsubstituted C₃-C₁₀-cycloalkyl; substituted or unsubstituted C₆-C₃₂-aryl. Most preferably, R¹⁴ and R¹⁵ may be OR′, wherein R′ is H, methyl, ethyl, or benzyl; and R¹⁶ may be selected from methyl, ethyl, phenyl, and benzyl.

In a further exemplary embodiment, R¹⁹ may be selected from substituted or unsubstituted C₁-C₁₀-alkyl, preferably methyl or ethyl; substituted or unsubstituted C₃-C₁₀-cycloalkyl; substituted or unsubstituted C₆-C₃₂-aryl; substituted or unsubstituted C₂-C₂₈-heteroaryl, substituted or unsubstituted C₂-C₂₀-alkynyl and substituted or unsubstituted C₂-C₂₀-alkenyl, the substituent may contain the atoms necessary to complete a cyclic structure with one of R⁵-R⁸ or R¹⁰-R¹³ forming an thioxanthone, acenaphthylene-1,2-dione, thiochroman-4-on, 9-fluorenone, anthraquinone, benzanthrone, 9,10-phenanthrenequinone, xanthone, 1,3-indanedione, chromone, 1,4-naphthoquinone, coumarin, more preferably R¹⁹ may be selected from substituted or unsubstituted phenyl or naphthyl. More preferably, if the selected substituent of R¹⁹ is additionally substituted, the additional substituent may be selected from the group consisting of H, D, methyl, alkyl, phenyl, CN, Cl, Br, F, methoxy, NMe₂, CF₃, SO₂Me, and SO₂NH₂.

In one preferred embodiment, the following formula:

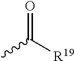

may be α-aminoacyl, α-N,N-dialkylamino-acyl, α-hydroxyacyl or α-alkoxyacyl.

Here halogen may be fluorine, chlorine, bromine, iodine.

Here alkyl, alkenyl, and alkynyl may be cyclic, linear, or branched.

Here alkyl acyl may have the following formula:

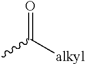

and aryl acyl may have the following formula:

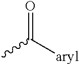

wherein the waved line represents the bond of the acyl group to the structure of formula (1).

In the case that one (or more) of the groups R¹-R¹³ is selected as amide, the bond can be made via the N as well as via the CO. In the case that one (or more) of the groups R¹-R¹³ is selected as ester, the bond can be made via the O as well as via the CO.

The above non-limiting examples of spiropyran-based photoinitiators are beneficial since experiments have shown that the color or coloring, respectively of three-dimensional objects which have been printed using these photoinitiators in a first step of the method have been efficiently changed by implementing a second step of the method.

In either case, the first step of the method can comprise a volumetric 3d-printing process in which a photopolymerizable material is arranged, e.g. via deposition, on a substrate and irradiated with light of at least one wavelength for photopolymerizing the photopolymerizable material to form a three-dimensional object on the substrate. The three-dimensional object can be or comprise a structure and/or a pattern on the substrate. The photopolymerizable material can be provided as a layer, particularly a layer having a layer thickness ranging between 5 nm and 1000 nm, particularly between 10 nm and 1000 nm. The substrate can be or comprise an electronic and/or optical component. Particularly, the substrate can be or comprise a semiconductor, e.g. a wafer. In such embodiments of the method, the second step of the method can be omitted.

As such, the present disclosure also relates, as an independent aspect, to a method for manufacturing a three-dimensional object, the method comprising a volumetric 3d-printing process in which a photopolymerizable material is arranged on a substrate and is irradiated with light of at least one wavelength for photopolymerizing the photopolymerizable material to form a three-dimensional object on the substrate, the three-dimensional object manufactured in accordance with the volumetric 3d-printing process having specific optical properties. Such a method can be implemented as a lithography-process, particularly for processing substrates, particularly electronic or optical substrates, such as e.g. semiconductors or wafers, respectively.

Preferably, in a respective lithography process a pattern or structure is formed on a substrate, preferably the substrate is a silicon wafer. A lithography process can comprise the use of a photoresist, preferably a negative photoresist, wherein the photoresist comprises a dual color photoinitiator. Hence, the photopolymerizable material can comprise a photoresist or vice versa.

A second aspect of the invention relates to an apparatus for conducting at least one measure to modify the optical properties of the three-dimensional object which has been manufactured via a volumetric 3d-printing process. The apparatus comprises at least one of a thermal treatment device configured to conduct at least one thermal treatment of a three-dimensional object which has been manufactured via a volumetric 3d-printing process which thermal treatment comprises tempering the three-dimensional object at at least one specific temperature for a specific time; an optical treatment device configured to conduct an optical treatment of a three-dimensional object which has been manufactured via a volumetric 3d-printing process which optical treatment comprises irradiating the three-dimensional object with light of at least one wavelength for a specific time, and a chemical treatment device configured to conduct at least one chemical treatment of a three-dimensional object which has been manufactured via a volumetric 3d-printing process which chemical treatment comprises effecting a reaction between at least one chemical modifying agent and the three-dimensional object.

The apparatus is particularly, configured to conduct the second step of the method according to the first aspect of the invention such that all remarks regarding the method according to the first aspect of the invention apply to the apparatus according to the second aspect of the invention and vice versa.

A third aspect of the invention relates to a system for manufacturing a three-dimensional object, the system comprising at least one volumetric 3d-printing apparatus and at least one apparatus according to the second aspect of the invention.

The system is particularly, configured to conduct the method according to the first aspect of the invention such that all remarks regarding the method according to the first aspect of the invention apply to the system according to the third aspect of the invention and vice versa.

The volumetric 3d-printing apparatus can comprise a container defining a working volume for receiving a photopolymerizable material and at least one radiation device configured to emit light of at least one wavelength so as to irradiate the photopolymerizable material received in the working volume with light of the at least one wavelength. Particularly, the at least one radiation device is configured to emit light of at least one first radiation device comprising at least one light source configured to irradiate light of a first wavelength into the working volume to generate at least one first light projection in the working volume. The at least one first light projection can comprise multiple light beams traversing the working volume in at least one light plane. The at least one light plane can also be deemed or denoted “common light plane”. The at least one first light projection and the at least one light plane, respectively can also be deemed or denoted a “light sheet”. As an example, the at least one first radiation device can comprise at least one optical element for generating the at least one light plane. The at least one optical element can comprise at least one of a Powell-lens, a cylindrical lens, a diffractive optical element, etc. Additionally or alternatively, the at least one first radiation device can comprise a light deflection unit, such as e.g. a galvo-scanner, or a polygon scanner, for generating the at least one light plane. The at least one first radiation device can thus be built as or comprise a light plane generator or a light sheet generator. The light as emitted or irradiated by the at least one first radiation device can comprise a wavelength in the range of: 350 nm-500 nm, particularly 375 nm-450 nm, more particularly 385 nm-440 nm, more particularly 395 nm-420, more particularly 400 nm-410 nm, for instance. The light of the first wavelength can comprise a spectrum of wavelengths, particularly at least partly covering the respective ranges. As an example, the first wavelength can range between 370 nm and 380 nm. Typically, the first wavelength will be chosen at least under consideration of the photochemical properties, particularly the photochromic properties, of molecules of the photoinitiator.

The apparatus can additionally comprise at least one further radiation device configured to continuously project a plurality of images of light of a further wavelength, the further wavelength being different from the first wavelength, into the working volume. Each image of the further wavelength can correspond to a specific portion, particularly a specific cross-section, of the at least one three-dimensional object to be manufactured with the apparatus. The at least one further radiation device can thus be built as or comprise an image projector, e.g. a digital light, DLP, projector. The light as emitted or irradiated by the at least one further radiation device can comprise a wavelength in the range of: 400 nm-1000 nm, particularly 425-750 nm, more particularly 450-675 nm, more particularly 500-650 nm, for instance. The light of the further wavelength can comprise a spectrum of wavelengths, particularly at least partly covering the respective ranges. Typically, the further wavelength will be chosen at least under consideration of the photochemical properties, particularly the photochromic properties, of molecules of the photoinitiator.

In exemplary embodiments in which the apparatus additionally comprises at least one further radiation device configured to continuously project a plurality of images, the at least one further radiation device can be configured to irradiate the light of the further wavelength into the working volume to generate a second light projection in the working volume, the second light projection intersecting the first light projection at a specific angle, particularly at an angle of 90°. Hence, the at least one light plane generated by the at least one first radiation device can be oriented at an angle, particularly at an angle of 90°, relative to the direction of projection of the plurality of images generated by the at least one further radiation device. In such embodiments, the local polymerization process of the photopolymerizable material and, thus the formation of a three-dimensional object can occur in the region in which the projected images generated by the at least one further radiation device intersect with the at least one light plane generated by the at least one first radiation device (and vice versa). As indicated above, the local polymerization process of the photopolymerizable material and, thus the formation of a three-dimensional object can take place continuously (which is one characteristic of volumetric 3d-printing relative to conventional additive manufacturing principles).

Typically, the projection of the plurality of images generated by the at least one further radiation device does not only overlay the at least one light plane generated by the at least one first radiation device but also has its focus plane in the at least one light plane. Notably, dynamic or static optical properties of the photopolymerizable material, such as the refractive index, can be considered for adjusting the focus plane of the projection of the plurality of images generated by the at least one further radiation device.

In exemplary embodiments, the working volume is moveable relative to a radiation device for emitting the light of the at least one wavelength into the working volume during the volumetric 3d-printing process. In such embodiments, the at least one radiation device can be not moveable (stationary) relative to the working volume. In other exemplary embodiments, the working volume is not moveable (stationary) relative to a radiation device for emitting the light of the at least one wavelength into the working volume during the volumetric 3d-printing process. In such embodiments, the at least one radiation device can be moveable relative to the working volume.

As far as CAL-processes or tomographic reproduction processes or tomographic back projection processes, respectively are implemented with the apparatus, the apparatus typically comprises a radiation device, e.g. a DLP-projector, configured to irradiate light images into a working volume containing a photopolymerizable material from different angles, wherein the superposition of the light images from multiple angles results in a three-dimensional accumulated energy dose sufficient to polymerize the material in the desired geometry. The radiation device can be stationary, whereas the working volume can be rotatable, particularly about a vertical rotation axis, relative to the radiation device while the radiation device projects respective light images into the working volume. Again, reference is made to the principles described in WO 2018/208 378 A2 or Kelly et al. Science, 2019, 363, 1075-1079: “Volumetric additive manufacturing via tomographic reconstruction”.

Preferably, the dual color photoinitiator comprises the structural motif of a spiropyran, a naphthopyran, or a spironaphthoxazin.

Preferably, the dual color photoinitiator comprises a derivative of one of the following structures:

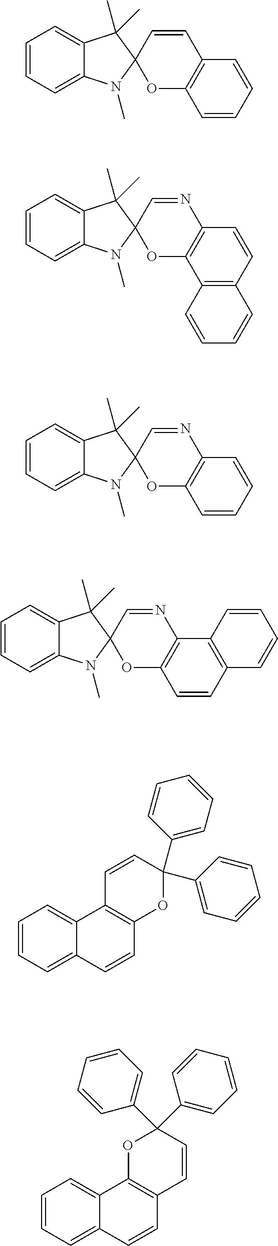 [SMILES: CN1c2ccccc2C(C)(C)C12C=Cc1ccccc1O2 ; CN1c2ccccc2C(C)(C)C12C=Nc1ccc3ccccc3c1O2 ; CN1c2ccccc2C(C)(C)C12C=Nc1ccccc1O2 ; CN1c2ccccc2C(C)(C)C12C=Nc1c(ccc3ccccc13)O2 ; C1=CC(c2ccccc2)(c2ccccc2)Oc2ccc3ccccc3c21 ; C1=CC(c2ccccc2)(c2ccccc2)Oc2c1ccc1ccccc21]

Preferably, the dual color photoinitiator is substituted with a carbonyl moiety, preferably the dual color photoinitiator is directly linked to a carbonyl moiety, preferably such that a carbon atom of a spiropyran, or a naphthopyran, or a spironaphthoxazin forms a bond to another carbon atom, wherein the other carbon atom forms a double bond to an oxygen atom.

Preferably, the dual color photoinitiator is substituted with at least one substituted or unsubstituted C₂-C₄₉-alkyl acyl; substituted or unsubstituted C₂-C₄₉-aryl acyl.

### BRIEF DESCRIPTION OF THE DRAWINGS

With these and other advantages and features that will become hereinafter apparent, a more complete understanding of the invention can be obtained by referring to the following description of the appended drawings in which:

FIG. 1 is a flow diagram of a method in accordance with an exemplary embodiment of the invention;

FIGS. 2-4 each show a diagram of the absorption properties of a three-dimensional object manufactured in accordance with exemplary embodiments of the invention and the absorption properties of reference objects;

FIG. 5 shows a principle drawing of an apparatus for conducting at least one measure to modify the optical properties of a three-dimensional object which has been manufactured via a volumetric 3d-printing process in accordance with an exemplary embodiment of the invention; and

FIG. 6 shows a principle drawing of a system for manufacturing a three-dimensional object in accordance with an exemplary embodiment of the invention.

### DETAILED DESCRIPTION OF THE DRAWINGS

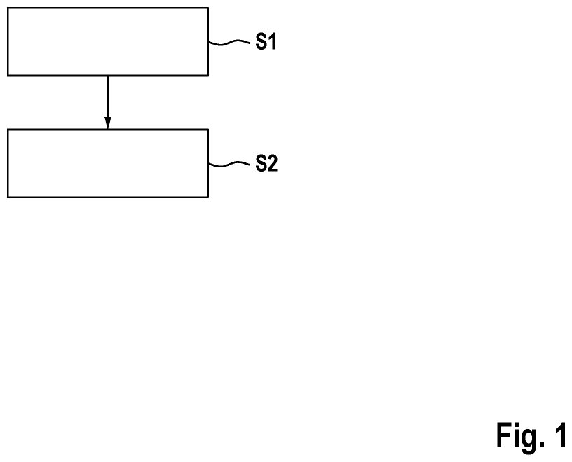

FIG. 1 is a flow diagram of a method for manufacturing a three-dimensional object in accordance with an exemplary embodiment of the invention.

The method comprises a first step S1 (step a)) which comprises a volumetric 3d-printing process in which a photopolymerizable material is irradiated with light of at least one wavelength for photopolymerizing the photopolymerizable material to form a three-dimensional object, the three-dimensional object manufactured in accordance with the volumetric 3d-printing process has specific optical properties; and a second step S2 (step b)), following the first step S1, which second step S2 comprises conducting at least one measure to modify the optical properties of the three-dimensional object.

The volumetric 3d-printing process which is conducted as the first step S1 can generally be or comprise any volumetric 3d-printing process which enables a continuous manufacture of a three-dimensional object. Particularly, the volumetric 3d-printing process which is conducted as the first step S1 can comprise at least one local polymerization process of a polymerizable material, particularly a photopolymerizable material, more particularly a photopolymerizable monomer resin, for the continuous additive manufacture of at least one three-dimensional object. Concrete, yet non-binding examples of a polymerizable material may include acrylates, methacrylates, thiol+ene, epoxides, oxiranes, oxetanes, or vinylethers, and/or a photopolymerizable oligomer resin, which may include but are not limited to acrylates, methacrylates, thiol+ene, epoxides, oxiranes, oxetanes, or vinylethers, for instance. The photopolymerizable material typically, also includes at least one photoinitiator, e.g. a spiropyran-based photoinitiator or a phosphine oxide based photoinitiator. The photopolymerizable material can also include at least one co-initiator, e.g. an amine-based co-initiator.

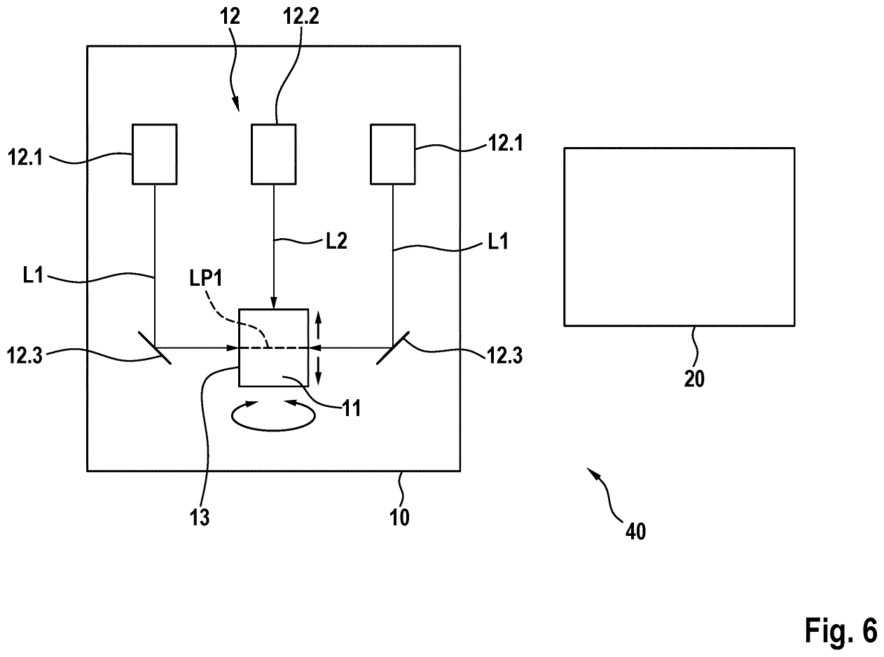

Respective local polymerization processes can comprise irradiating the at least one photoinitiator of the photopolymerizable material with light of at least one wavelength to convert the molecules of the at least one photoinitiator via optical excitation, particularly sequential optical excitation, into a reactive state in which the molecules of the at least one photoinitiator locally trigger a polymerization reaction of the polymerizable material in a working volume of a volumetric 3d-printing apparatus used for performing the volumetric 3d-printing process of the first step. Particularly, photopolymerization of the polymerizable material can be effected inside a working volume 11 of a respective volumetric 3d-printing apparatus 10 (see FIG. 6) by irradiating light of at least one first wavelength and light of at least one further wavelength, which further wavelength is different from the first wavelength, into the working volume 11 of the volumetric 3d-printing apparatus 10, which results in that the molecules of the at least one photoinitiator are converted, e.g., due to the absorption of light of the first wavelength, from an initial state in which the molecules of the at least one photoinitiator (substantially) do not absorb the light of the further wavelength, into an intermediate state in which the molecules of the at least one photoinitiator absorb the light of the further wavelength which results in that the molecules of the at least one photoinitiator are transferred from the intermediate state to the reactive state which locally triggers the polymerization of the photopolymerizable material to continuously manufacture at least one three-dimensional object inside the working volume 11 of the volumetric 3d-printing apparatus 10. A back reaction of the molecules of the at least one photoinitiator from the intermediate state into the initial state can be thermally induced, for instance.

Particularly, the volumetric 3d-printing process can comprise irradiating the photopolymerizable material with light of the at least one wavelength in a respective working volume 11, wherein the working volume 11 is moveable or moved relative to a radiation device 12 of the volumetric 3d-printing apparatus 10, the radiation device 12 emitting the light of the at least one wavelength during the volumetric 3d-printing process. As such, the volumetric 3d-printing process can be a process in which the working volume 11 is moved relative to a radiation device 12 emitting the light of the at least one wavelength during the volumetric 3d-printing process. A respective motion of the working volume 11 can be a translation motion along a translation axis, as implemented in so-called xolography processes, and/or a rotational motion about a rotational axis, as implemented in computed axial lithography, CAL, processes, for instance.

Notably, the volumetric 3d-printing process which is conducted as the first step S1 can thus be or comprise a volumetric 3d-printing process denoted as xolography which is specified in WO 2020/245456 A1, the contents of which are incorporated herein by reference.

Alternatively, the volumetric 3d-printing process can comprise irradiating the photopolymerizable material with light of the at least one wavelength in a respective working volume 11, wherein the working volume 11 is not moved, i.e. at least not translatorily moved, relative to a radiation device 11 of the volumetric 3d-printing apparatus 10, the radiation device 12 emitting the light of the at least one wavelength during the volumetric 3d-printing process. As such, the volumetric 3d-printing process can be a process in which the working volume 11 is not moved, i.e. at least not translatorily moved, relative to a radiation device 12 emitting the light of the at least one wavelength during the volumetric 3d-printing process. Still, rotational movements of the working volume 11, e.g. about a vertical axis, are conceivable as implemented in a computed axial lithography, CAL, process, for instance.

As a concrete example, the volumetric 3d-printing process which is conducted as the first step can thus be or comprise a multi-color photopolymerization process, particularly a dual-color photopolymerization process, a multi-photon photopolymerization process, or a respective computed axial lithography, CAL, process, for instance.

In either case, the three-dimensional object which has been manufactured in the first step S1 has specific optical properties. Particularly, the optical properties of the three-dimensional object which has been manufactured in the first step S1 refer to the absorption properties of the three-dimensional object in the visible wavelength range (375 nm-800 nm). Hence, the optical properties of the three-dimensional object can relate to a specific color or coloring, respectively of the three-dimensional object in the visible wavelength range. Generally, the concrete color or coloring, respectively of the three-dimensional object depends on the concrete chemical configuration and the related optical properties in the visible wavelength range, particularly the absorption properties in the visible wavelength range, of the chromophores used for printing of the three-dimensional object and/or the chromophores contained within the three-dimensional object. Oftentimes, the optical properties of the three-dimensional object result in that the three-dimensional object has a yellow(ish) color or coloring, respectively. This particularly, applies when the polymerizable material used in the volumetric 3d-printing process comprises dual-color photoinitiators, such as e.g. naphthopyran-based or spiropyran-based photoinitiators, i.e. photoinitiators of the spiropyran/merocyanine system in which the spiropyran form is the thermodynamically preferred form which undergoes a ring-opening reaction upon irradiation with light of a first wavelength which results in that the spiropyran form is transferred in the metastable merocyanine form which can be transferred, particularly by absorption of light of a further wavelength, into the reactive state. The same applies to other photoinitiators, such as but not limited to the photoinitiators shown in [Green, Industrial Photoinitiators A Technical Guide, CRC Press, 2010; Fouassier and Lalevee, Photoinitiators for Polymer Synthesis: Scope, Reactivity and Efficiency, Wiley VCH, 2012], for instance.

The method comprises a second step S2 of conducting at least one measure to modify the optical properties of the three-dimensional object. The method thus comprises a separate step of conducting at least one measure to modify the optical properties of the three-dimensional object after the first step S1 in which a three-dimensional object has been printed. The method therefore, enables deliberately modifying the optical properties, particularly the absorption properties, of the three-dimensional object which result from the volumetric 3d-printing process in the visible wavelength range. As such, a three-dimensional object can generally be provided with modified optical properties, particularly modified absorption properties, after completion of the first step.

As an example, a three-dimensional object can initially have a first color or coloring, respectively after the first step S1, the first color or coloring, respectively resulting from the volumetric 3d-printing process, and has higher transparency, e.g. less color or coloring, respectively or no color or coloring, respectively, after completion of the second step S2. Particularly, the resulting optical properties, particularly the resulting absorption properties, of the three-dimensional after completion of the second step S2 may result in that the three-dimensional object is transparent in the visible wavelength range. Hence, the three-dimensional object can show no or only little absorption in the visible wavelength range after completion of the second step S2. Transparency in the visible wavelength range typically means that the transmission of the three-dimensional object in the visible wavelength range is above 80%.

Particularly, the at least one measure of conducting at least one measure to modify the optical properties of the three-dimensional object in accordance with the second step S2 can comprise modifying the optical properties of the three-dimensional object resulting in an absorption per mm of thickness of the three-dimensional object of less than 0.5, particularly less than 0.3, more particularly less than 0.2, more particularly less than 0.1, for at least one wavelength in a wavelength range between 300 nm and 2000 nm, particularly 350 nm and 900 nm, more particularly 400 nm and 800 nm.

Particularly, the absorption per mm of thickness of the three-dimensional object is less than 0.5, particularly less than 0.3, more particularly less than 0.2, more particularly less than 0.1, for each wavelength in the wavelength range between 300 nm and 2000 nm, particularly 350 nm and 900 nm, more particularly 400 nm and 800 nm.

The absorption and/or transmission of the three-dimensional object can be determined with a UV-Vis-NIR spectrophotometer of the type “Cary 50” available from Agilent Technologies, Inc., for instance.

The second step S2 is conducted when the first step S1 has been (entirely) completed. Completion of the first step S1, i.e. completion of the 3d-printing process of a three-dimensional object is typically, given when no further photopolymerization is effected in the working volume 11 of a respective volumetric 3d-printing apparatus 10 by irradiating the photopolymerizable material in the working volume 11 of the volumetric 3d-printing apparatus 10 with at least one radiation device 12 of the volumetric 3d-printing apparatus. As such, completion of the 3d-printing process of a three-dimensional object is typically, given when the printed three-dimensional object has a pre-defined geometric configuration, particularly a pre-defined shape, or the green state of the three-dimensional object has a pre-defined shape. As such, after completion of the first step S1, the printed three-dimensional object can still be disposed in the working volume 11 of the of the volumetric 3d-printing apparatus 10 in which it has been printed. Hence, the second step S2 can be conducted when the three-dimensional object which has been printed in the first step S1 is still within the working volume 11 of the volumetric 3d-printing apparatus 10 used for carrying out the first step S1.

The at least one measure to modify the optical properties of the three-dimensional object can comprise modifying the optical properties of the three-dimensional object such that the absorption of the three-dimensional object is decreased for at least one wavelength in a wavelength range between 300 nm and 2000 nm, particularly in a wavelength range between 350 nm and 1750 nm, more particularly in a wavelength range between 350 nm and 1500 nm, more particularly in a wavelength range between 350 nm and 1250 nm, more particularly in a wavelength range between 350 nm and 1000 nm, more particularly in a wavelength range between 375 nm and 900 nm, more particularly in a wavelength range between 400 nm and 800 nm, such that the transmissive properties of the three-dimensional object are increased for at least one wavelength in the aforementioned wavelength ranges. As such, the second step S2 can result in a decrease of the absorption properties of the three-dimensional object for at least one wavelength in a wavelength range between 300 nm and 2000 nm, particularly in a wavelength range between 350 nm and 1750 nm, more particularly in a wavelength range between 350 nm and 1500 nm, more particularly in a wavelength range between 350 nm and 1250 nm, more particularly in a wavelength range between 350 nm and 1000 nm, more particularly in a wavelength range between 375 nm and 900 nm, more particularly in a wavelength range between 400 nm and 800 nm, and in an increase of the transmissive properties of the three-dimensional object for at least one wavelength in the wavelength range between 300 nm and 2000 nm, particularly in a wavelength range between 350 nm and 1750 nm, more particularly in a wavelength range between 350 nm and 1500 nm, more particularly in a wavelength range between 350 nm and 1250 nm, more particularly in a wavelength range between 350 nm and 1000 nm, more particularly in a wavelength range between 375 nm and 900 nm, more particularly in a wavelength range between 400 nm and 800 nm. As indicated above, conducting the second step S2 of the method can particularly, comprise modifying the absorption properties of the three-dimensional object such that the three-dimensional object is transparent in the visible wavelength range. As also indicated above, a three-dimensional object which has a specific color or coloring, respectively after completion of the first step can be colorless after completion of the second step.

The at least one measure to modify the optical properties of the three-dimensional object can comprise a thermal treatment of the three-dimensional object which thermal treatment comprises tempering the three-dimensional object at at least one specific temperature for a specific time. Particularly, thermally modifying the optical properties of the three-dimensional object can comprise thermally altering and/or degrading chromophores in the three-dimensional object and/or thermally generating reactive species in the three-dimensional object which alter and/or degrade chromophores in the three-dimensional object based on tempering the three-dimensional object for a specific time. As such, the three-dimensional object can be subject to a thermal treatment which thermal treatment comprises tempering the three-dimensional object at at least one specific temperature for a specific time (“tempering time”) after completion of the first step S1. The concrete parameters for tempering the three-dimensional object, i.e. particularly the at least one specific temperature and the specific time, will typically be chosen under consideration of at least one chemical parameter of the three-dimensional object and/or at least one physical parameter of the three-dimensional object. A respective chemical parameter can be the chemical composition of the three-dimensional object, particularly the chemical composition of the chromophores of the three-dimensional object, for instance. A respective physical parameter can be at least one of an optical property, e.g. color, a surface property, a geometric property, e.g. dimensions, shape, volume, etc. of the three-dimensional object, for instance. Particularly, chemical and/or physical parameters affecting the penetration of thermal energy into the three-dimensional object are considered for choosing concrete parameters for tempering the three-dimensional object such that a complete penetration of thermal energy into the three-dimensional object is possible resulting in that the optical properties of the three-dimensional object can be changed throughout its entire volume. However, it is also conceivable that only a partial penetration of thermal energy into the three-dimensional object is desired. In such cases, concrete parameters for tempering the three-dimensional object are chosen such that only a partial penetration of thermal energy into the three-dimensional object is achieved. A partial penetration of thermal energy into the three-dimensional object can generally mean that thermal energy only penetrates into surface regions of the three-dimensional object. Respective penetration depths can comprise depths ranging between 10 μm and 500 μm, particularly between 10 μm and 250 μm, more particularly between 10 μm and 100 μm, from the freely exposed surface of the three-dimensional object, for instance.

Tempering can comprise heating the three-dimensional object at a specific heating temperature for a specific time. Heating the three-dimensional object can result in that the structure of chromophores of the three-dimensional object is altered and/or degraded. Respective chromophores of the three-dimensional object can e.g. comprise residual chromophore photoinitiator molecules, residual co-initiator molecules, photopolymerized polymer resin, etc. Additionally or alternatively, heating the three-dimensional object can result in that a reactive chemical species is generated which reacts with the chromophores such that the structure of the chromophores of the three-dimensional object is altered and/or degraded. Altering the structure of chromophores of the three-dimensional object can be based on a thermally induced chemical reaction of the chromophores and/or a thermally induced rearrangement of parts, e.g. moieties, of the chromophores, for instance. Degrading the structure of chromophores of the three-dimensional object can be based on a thermally induced chemical and/or physical degradation reaction of the chromophores, for instance. Both alteration and/or degradation of the chromophores results in different optical properties of the three-dimensional object. As such, the color or coloring, respectively which a three-dimensional object has after completion of the first step can be changed or removed via a respective thermal treatment such that, after completion of the second step, the three-dimensional object has higher transmittance and/or lower absorbance which results in less color or coloring, respectively or no color or coloring, respectively.

Exemplary temperatures can range between 30° C. to 1000° C., particularly between 40° C. and 500° C., more particularly between 50° C. and 200° C., more particularly between 60° C. and 150°, more particularly between 70° C. and 120° C. As noted above, concrete parameters typically, depend on at least one chemical parameter of the three-dimensional object and/or at least one physical parameter of the three-dimensional object. Also, the tempering times will be considered for choosing a suitable temperature or temperature range, respectively.

Exemplary tempering times can range between 0.5 min and 5 days, particularly between 1 min and 1 day, more particularly between 1 min and 24 h, more particularly between 5 min and 12 h, more particularly between 10 min and 4 h, more particularly between 15 min and 3 h, more particularly between 15 min and 2 h, more particularly between 15 min and 1 h, more particularly between 15 min and 45 min, more particularly between 15 min and 30 min. As noted above, concrete parameters typically, depend on at least one chemical parameter of the three-dimensional object and/or at least one physical parameter of the three-dimensional object. Also, the temperatures or temperature ranges, respectively will be considered for choosing a suitable tempering time.

A respective thermal treatment can be effected when the three-dimensional object is disposed within the working volume 11 in which it has been printed or when the three-dimensional object has been removed from the working volume 11 in which it has been printed. In the latter case, it is conceivable that the three-dimensional object undergoes at least one cleaning step in which residual photopolymerizable material is removed from the surface of the three-dimensional object, before the thermal treatment is initiated.

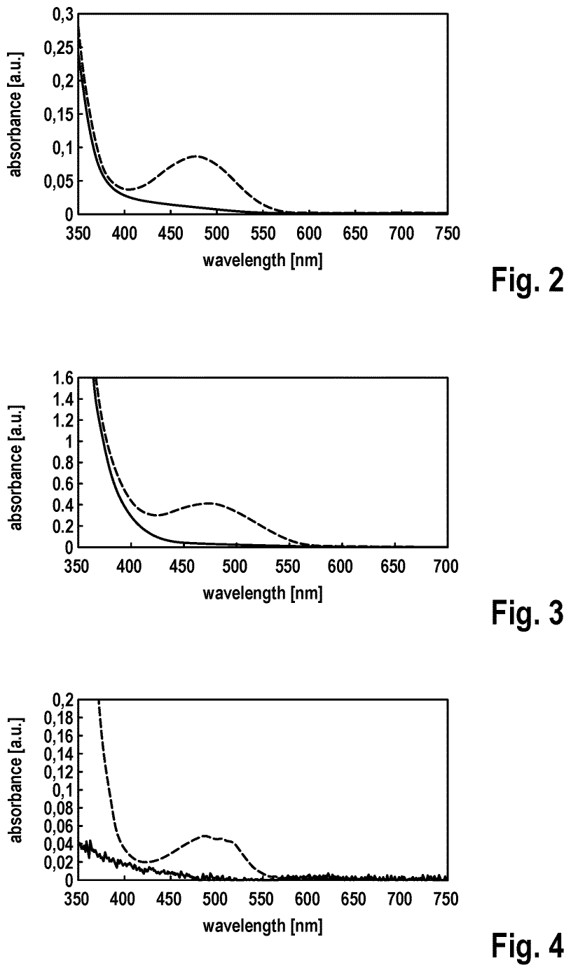

FIG. 2 shows a diagram of the absorption properties (see y-axis indicating the absorption with “absorbance units” a.u.) of a three-dimensional object manufactured in accordance with exemplary embodiments of the invention before conducting the second step S2 (see dashed line) and the absorption properties of the same three-dimensional object after conducting the second step S2 (see black line) over the wavelength range between 350 nm and 750 nm (see x-axis).

The three-dimensional object has been printed with a xolography apparatus available from xolo GmbH, Berlin, from a photopolymerizable material comprising 0.04 wt.-% of a dual color photoinitiator of formula (2) below, in a resin of UDMA (Urethane dimethacrylate (CAS: 72869-86-4), containing 5 wt.-% DiTMPTA (Di(trimethylolpropane)tetraacrylate), 5 wt.-% MDEA (N-Methyldiethanolamine), 1.5 wt. % HDDA (1,6-hexandiol diacrylate), 0.5 wt.-% ACMO (Acryloyl morpholine). The diagram shows (see the dashed line) that the three-dimensional object has, after dual color polymerization with 375 nm and 617 nm, an absorption band around 470 nm resulting in a yellowish color or coloring, respectively of the three-dimensional object.

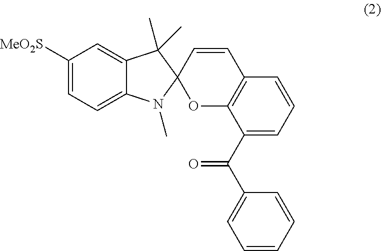 [SMILES: CN1c2ccc(S(C)(=O)=O)cc2C(C)(C)C12C=Cc1cccc(C(=O)c3ccccc3)c1O2]

In the experiment underlying the representation of FIG. 2, the three-dimensional object has been taken out of the working volume 11, residual photopolymerizable material has been removed by washing in a washing solution containing ethanol, and the three-dimensional object has been placed in a heatable chamber of a thermal treatment device in which the three-dimensional object has been tempered at 120° C. for 30 min which resulted in that (see the black line), the absorption in the visible wavelength range is significantly reduced. As such, a transparent three-dimensional object is obtained in accordance with this exemplary embodiment of the invention.

The test object of the experiment underlying the representation of FIG. 2 had a rectangular shape with the following dimensions: width 8 mm, height 16 mm, thickness 1 mm.

Additionally or alternatively to a thermal treatment, the at least one measure to modify the optical properties of the three-dimensional object can comprise an optical treatment of the three-dimensional object which optical treatment comprises irradiating the three-dimensional object with light of at least one wavelength for a specific time. Particularly, optically modifying the optical properties of the three-dimensional object can comprise optically altering and/or degrading chromophores in the three-dimensional object and/or optically generating reactive species in the three-dimensional object which alter and/or degrade chromophores in the three-dimensional object based on irradiating the three-dimensional object with light of at least one wavelength for a specific time. As such, the three-dimensional object can be subject to an optical treatment which optical treatment comprises irradiating the three-dimensional object with light of at least one wavelength and/or intensity for a specific time (“irradiation time”) after completion of the first step. The concrete parameters for irradiating the three-dimensional object, i.e. particularly the at least one wavelength and the specific time, will typically be chosen under consideration of at least one chemical parameter of the three-dimensional object and/or at least one physical parameter of the three-dimensional object. The irradiation time typically, depends on the intensity of the light. The intensity of the light can range between 0.0001-100 W/cm², particularly between 0.001-10 W/cm², more particularly between 0.1-3 W/cm², for instance. A respective chemical parameter can be the chemical composition of the three-dimensional object, particularly the chemical composition of the chromophores of the three-dimensional object, for instance. A respective physical parameter can be at least one of an optical property, e.g. color, a surface property, a geometric property, e.g. dimensions, shape, volume, etc. of the three-dimensional object, for instance. Particularly, chemical and/or physical parameters affecting the penetration of light energy into the three-dimensional object are considered for choosing concrete parameters for irradiating the three-dimensional object such that a complete penetration of light energy into the three-dimensional object is possible resulting in that the optical properties of the three-dimensional object can be changed throughout the entire volume. However, it is also conceivable that only a partial penetration of light energy into the three-dimensional object is desired. In such cases, concrete parameters for irradiating the three-dimensional object are chosen such that only a partial penetration of light energy into the three-dimensional object is achieved. A partial penetration of light energy into the three-dimensional object can generally mean that light energy only penetrates into surface regions of the three-dimensional object. Respective penetration depths can comprise depths ranging between 10 μm and 500 μm, particularly between 10 μm and 250 μm, more particularly between 10 μm and 100 μm, from the freely exposed surface of the three-dimensional object, for instance.

Exemplary wavelengths can range between 350 nm and 1000 nm, particularly between 350 nm and 800 nm, more particularly between 400 nm and 500 nm or between 420 nm and 800 nm. As noted above, concrete parameters typically, depend on at least one chemical parameter of the three-dimensional object and/or at least one physical parameter of the three-dimensional object. Also, the irradiation times will be considered for choosing a suitable wavelength or wavelength range, respectively.

Exemplary irradiation times can range between 1 s and 24 h, particularly 1 s and 12 h, more particularly between 1 s and 6 h, more particularly between 1 s and 3 h, more particularly between 0.5 min and 150 min, more particularly between 0.5 min and 120 min, more particularly 1 min and 90 min, more particularly between 1 min and 60 min, more particularly between 1 min and 45 min, more particularly between 1 min and 30 min. As noted above, concrete parameters typically, depend on at least one chemical parameter of the three-dimensional object and/or at least one physical parameter of the three-dimensional object. Also, the wavelength or wavelength ranges, respectively will be considered for choosing a suitable irradiation time.

Irradiating the three-dimensional object with light of at least one wavelength, which also covers irradiating the three-dimensional object with light of multiple wavelengths, e.g. a spectrum of wavelengths, can result in that the structure of chromophores of the three-dimensional object is altered and/or degraded. Particularly, multiple wavelengths can be used which overlay with the absorption spectrum of the chromophores of the three-dimensional object which are to be altered and/or degraded. Respective chromophores of the three-dimensional object can e.g. comprise residual chromophore photoinitiator molecules, residual co-initiator molecules, photopolymerized polymer resin, etc. Altering the structure of chromophores of the three-dimensional object can be based on a photon induced chemical reaction of the chromophores and/or a photon induced rearrangement of parts, e.g. moieties, of the chromophores, for instance. Degrading the structure of chromophores of the three-dimensional object can be based on a photon induced chemical and/or physical degradation reaction of the chromophores, for instance. Both alteration and/or degradation of the chromophores results in different optical properties of the three-dimensional object. As such, the color or coloring, respectively which a three-dimensional object has after completion of the first step can be changed or removed via a respective optical treatment such that, after completion of the second step, the three-dimensional object has higher transmittance and/or lower absorbance which results in less color or coloring, respectively or no color or coloring, respectively.

A respective optical treatment can be effected when the three-dimensional object is disposed within the working volume 11 in which it has been printed or when the three-dimensional object has been removed from the working volume 11 in which it has been printed. In the latter case, it is conceivable that the three-dimensional object undergoes a cleaning step in which residual photopolymerizable material is removed from the surface of the three-dimensional object, before the optical treatment is initiated.

FIG. 3 shows a diagram of the absorption properties (see y-axis indicating the absorption with “absorbance units” a.u.) of a three-dimensional object manufactured in accordance with exemplary embodiments of the invention before conducting the second step S2 (see dashed line) and the absorption properties of the same three-dimensional object after conducting the second step S2 (see black line) over the wavelength range between 350 nm and 750 nm (see x-axis).

The three-dimensional object has been printed with a xolography apparatus available from xolo GmbH, Berlin, from a photopolymerizable material comprising 0.06 wt.-% of a dual color photoinitiator of formula (2) below in a resin of UDMA (Urethane dimethacrylate (CAS: 72869-86-4), containing 5 wt.-% ACMO (Acryloyl morpholine) and 4 wt.-% MDEA (N-Methyldiethanolamine). The diagram shows (see the dashed line) that the three-dimensional object has, after dual color polymerization with 375 nm and 617 nm, an absorption band around 470 nm resulting in a yellowish color or coloring, respectively of the three-dimensional object.

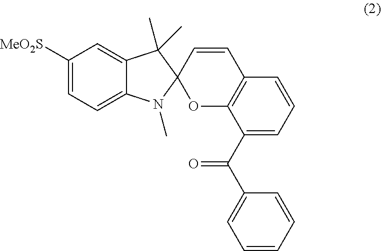 [SMILES: CN1c2ccc(S(C)(=O)=O)cc2C(C)(C)C12C=Cc1cccc(C(=O)c3ccccc3)c1O2]

In the experiment underlying the representation of FIG. 3, the three-dimensional object and the residual photopolymerizable material have been left in the working volume 11 and the three-dimensional object has been subjected to irradiation with light of a wavelength of 420 nm for 30 min (Thorlabs M420L3, 750 mW) within the working volume 11 which resulted in that (see the black line), the absorption of the object in the visible wavelength range is significantly reduced. As such, a transparent three-dimensional object is obtained in accordance with this exemplary embodiment of the invention.

The test object of the experiment underlying the representation of FIG. 3 had a rectangular shape with the following dimensions: width 8 mm, height 16 mm, thickness 8 mm.

Additionally or alternatively to a thermal treatment and/or an optical treatment, the at least one measure to modify the optical properties of the three-dimensional object can comprise a chemical treatment of the three-dimensional object with at least one chemical modifying agent. The at least one chemical modifying agent can be a solid, a liquid, or a gas. Particularly, chemically modifying the optical properties of the three-dimensional object can comprise chemically altering and/or degrading chromophores in the three-dimensional object and/or chemically generating reactive species in the three-dimensional object which alter and/or degrade chromophores in the three-dimensional object based on a reaction of the three-dimensional object with the at least one chemical modifying agent. As such, the three-dimensional object can be subject to a chemical treatment which chemical treatment comprises subjecting the three-dimensional object to at least one chemical modifying agent or a mixture, particularly a solution, containing the at least one chemical modifying agent for a specific time (“reaction time”) after completion of the first step. The concrete chemical parameters of the chemical reaction, e.g. type of chemical reaction, between the at least one chemical modifying agent and the three-dimensional object or respective chromophores of the three-dimensional, respectively object will typically be chosen under consideration of at least one chemical parameter of the three-dimensional object and/or at least one physical parameter of the three-dimensional object. A respective chemical parameter can be the chemical composition of the three-dimensional object, particularly the chemical composition of the chromophores of the three-dimensional object, for instance. A respective physical parameter can be at least one of an optical property, e.g. color, a surface property, a geometric property, e.g. dimensions, shape, volume, etc. of the three-dimensional object, for instance. Particularly, chemical and/or physical parameters affecting the reactivity of the three-dimensional object are considered for choosing concrete parameters for the chemical reaction between the at least one chemical modifying agent and the three-dimensional object such that a chemical reaction of the complete three-dimensional object is possible resulting in that the optical properties of the three-dimensional object can be changed throughout the entire volume. However, it is also conceivable that only a partial chemical reaction of the three-dimensional object is desired. In such cases, concrete parameters for the chemical reaction, such as e.g. concentration of the at least one chemical modifying agent, of the three-dimensional object are chosen such that only a partial chemical reaction of the three-dimensional object is achieved. A partial chemical reaction of the three-dimensional object can generally mean that only surface regions of the three-dimensional object react. Respective surface portions can comprise depths ranging between 10 μm and 500 μm, particularly between 10 μm and 250 μm, more particularly between 10 μm and 100 μm, from the freely exposed surface of the three-dimensional object, for instance.

The chemical reaction between the at least one chemical modifying agent and the three-dimensional object can result in that the structure of chromophores of the three-dimensional object is altered and/or degraded. Respective chromophores of the three-dimensional object can e.g. comprise residual chromophore photoinitiator molecules, residual co-initiator molecules, photopolymerized polymer resin, etc. Altering the structure of chromophores of the three-dimensional object can thus be based on a chemical reaction of the at least one chemical modifying agent with the chromophores which can effect a rearrangement of parts, e.g. moieties, of the chromophores, for instance. Degrading the structure of chromophores of the three-dimensional object can be based on a chemical reaction of the at least one chemical modifying agent with the chromophores which can effect a chemical degradation of the chromophores, for instance. Both alteration and/or degradation of the chromophores results in different optical properties of the three-dimensional object. As such, the color or coloring, respectively which a three-dimensional object has after completion of the first step can be changed or removed via a respective chemical treatment such that, after completion of the second step, the three-dimensional object has higher transmittance and/or lower absorbance which results in less color or coloring, respectively or no color or coloring, respectively.

The at least one chemical modifying agent can be configured, i.e. have a chemical structure, to alter the chromophore properties of chromophores, particularly residual photoinitiator molecules, of the photopolymerizable material and/or chromophores resulting from the photopolymerization process. Additionally or alternatively, the at least one chemical modifying agent can be configured, i.e. have a chemical structure, to generate a reactive agent configured to alter the chromophore properties of chromophores, particularly residual photoinitiator molecules, of the photopolymerizable material or photopolymerized material forming the three-dimensional object. Altering the chromophore properties of the chromophores can in either case particularly, comprise degrading chromophore groups of the chromophores. Altering the chromophore properties of the chromophores via the at least one chemical modifying agent can in either case be effected under the influence of energy, particularly thermal energy and/or photon energy.

As an example, the at least one chemical modifying agent can be or comprise at least one of an oxidizing agent, particularly an oxidizing acid, particularly a peroxyacid, or at least one reducing agent, particularly a reducing base, or a salt, particularly a sulfonium-based salt or an iodonium-based salt, configured to alter, particularly degrade, chromophores, particularly residual photoinitiator molecules, of the three-dimensional object.

As an alternate or additional example, the at least one chemical modifying agent can be or comprise a chlorine-based substance, particularly chlorine, hypochlorite, chlorine dioxide, or an oxygen-based substance, particularly ozone, oxygen, peroxide, perborate, percarbonate, peracetic acid.

Exemplary reaction times can range between 1 min and 24 h, more particularly between 5 min and 12 h, more particularly between 10 min and 4 h, more particularly between 15 min and 3 h, more particularly between 15 min and 2 h, more particularly between 15 min and 1 h, more particularly between 15 min and 45 min, more particularly between 15 min and 30 min. As noted above, concrete parameters typically, depend on at least one chemical parameter of the three-dimensional object and/or at least one physical parameter of the three-dimensional object.

A respective chemical treatment can be effected when the three-dimensional object is disposed within the working volume 11 in which it has been printed or when the three-dimensional object has been removed from the working volume 11 in which it has been printed. In the latter case, it is conceivable that the three-dimensional object undergoes at least one cleaning step in which residual photopolymerizable material is removed from the surface of the three-dimensional object, before the chemical treatment is initiated.

It is conceivable that the at least one chemical modifying agent is added to the photopolymerizable material before and/or during formation of the three-dimensional object. Hence, the first step S1 of the method can comprise adding the at least one chemical modifying agent to the photopolymerizable material before and/or during formation of the three-dimensional object. As such, the at least one chemical modifying agent can form part of the three-dimensional object such that, in the second step S2, the chemical reaction needs only to be initiated by subjecting the three-dimensional object to suitable chemical and/or physical conditions which enable initiating the chemical reaction. As an example, the chemical reaction can be initiated by applying energy, e.g. thermal energy and/or light energy, to the three-dimensional object.

It is also conceivable that the at least one chemical modifying agent is added after forming the three-dimensional object. Hence, the second step S2 may comprise adding at least one chemical modifying agent to the three-dimensional object or the photopolymerized material forming the three-dimensional object after forming the three-dimensional object. As such, the at least one chemical modifying agent does not necessarily have to form part of the three-dimensional object before the second step S2 such that, in the second step S2, first the at least one chemical modifying agent needs to be added to the three-dimensional object and then the chemical reaction needs to be initiated by subjecting the three-dimensional object to suitable chemical and/or physical conditions which enable initiating the chemical reaction. As an example, the chemical reaction can be initiated by applying energy, e.g. thermal energy and/or light energy, to the three-dimensional object. Alternatively, the chemical reaction can be initiated by means of a chemical initiating agent.

In embodiments in which the at least one chemical modifying agent is added to the photopolymerized material after forming the three-dimensional object, the three-dimensional object can be placed in a solution containing the at least one chemical modifying agent for a specific time. When the three-dimensional object is placed in the solution, the at least one chemical modifying agent can migrate from the solution into the three-dimensional object. Optionally residual co-initiator and/or residual photoinitiator can migrate from the three-dimensional object into the solution. A respective solution can thus comprise at least one solvent, particularly an inert organic solvent, e.g. cyclohexane or ethanol, and the at least one chemical modifying agent. This particularly, applies to embodiments in which the at least one chemical modifying agent is a liquid. A concrete example of a solution can comprise a mixture of 70% ethanol, 10% acetic acid, and 20% aqueous hydrogen peroxide (30% H₂O₂).

In further embodiments in which the at least one chemical modifying agent is added to the photopolymerized material after forming the three-dimensional object, the three-dimensional object can be placed in an atmosphere containing the at least one chemical modifying agent for a specific time, a specific temperature, and a specific pressure, for instance. When the three-dimensional object is placed in the atmosphere, the at least one chemical modifying agent can migrate from the atmosphere into the three-dimensional object. A respective atmosphere thus comprises at least one reactive gas, particularly oxygen and/or ozone and/or hydrogen, chlorine and/or chlorine compounds, such as HCl, for instance.

FIG. 4 shows a diagram of the absorption properties (see y-axis indicating the absorption with “absorbance units” a.u.) of a three-dimensional object manufactured in accordance with exemplary embodiments of the invention before conducting the second step S2 (see dashed line) and the absorption properties of the same three-dimensional object after conducting the second step S2 (see black line) over the wavelength range between 350 nm and 750 nm (see x-axis).

The three-dimensional object has been printed with a xolography apparatus available from xolo GmbH, Berlin, from a photopolymerizable material comprising 0.015 wt.-% of a dual color photoinitiator of formula (3) below in a resin of UDMA (Urethandimethacrylate (CAS: 72869-86-4), containing 10 wt.-% TMPTA (Trimethylolpropantriacrylate) and 5 wt.-% MDEA (N-Methyldiethanolamine). The diagram shows (see the dashed line) that the three-dimensional object has, after dual color polymerization with 405 nm and 617 nm, an absorption band around 500 nm resulting in a yellowish color or coloring, respectively of the three-dimensional object.

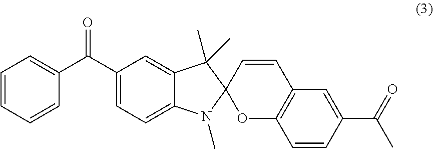 [SMILES: CC(=O)c1ccc2c(c1)C=CC1(O2)N(C)c2ccc(C(=O)c3ccccc3)cc2C1(C)C]

In the experiment underlying the representation of FIG. 4, the three-dimensional object has been taken out of the working volume 11, residual photopolymerizable material has been removed by washing in a washing solution containing ethanol, and the three-dimensional object has been placed in a solution of 70% ethanol, 10% acetic acid, and 20% aqueous hydrogen peroxide (30% H₂O₂) for 12 h which resulted in that (see the black line), the absorption in the visible wavelength range is significantly reduced. As such, a transparent three-dimensional object is obtained in accordance with this exemplary embodiment of the invention.

The test object of the experiment underlying the representation of FIG. 4 had a rectangular shape with the following dimensions: width 8 mm, height 16 mm, thickness 1 mm.

In all experiments represented by FIGS. 2-4, absorption has been measured along the thickness direction (path length 1 mm or 8 mm) with a UV-Vis-NIR spectrophotometer of the type “Cary 50” available from Agilent Technologies, Inc. The three-dimensional objects of the respective experiments have been placed in the optical path of the spectrophotometer such that the measurement light completely passed through.

Further, in all experimental data underlying the representations of FIGS. 2-4, the scattering which occurs during the polymerization is corrected for by subtraction of the mean absorbance between 750 and 800 nm for better visibility. However, this method does not correct for the larger scattering at lower wavelength, which is why a remaining apparent absorbance in the black spectrum can still be visible.

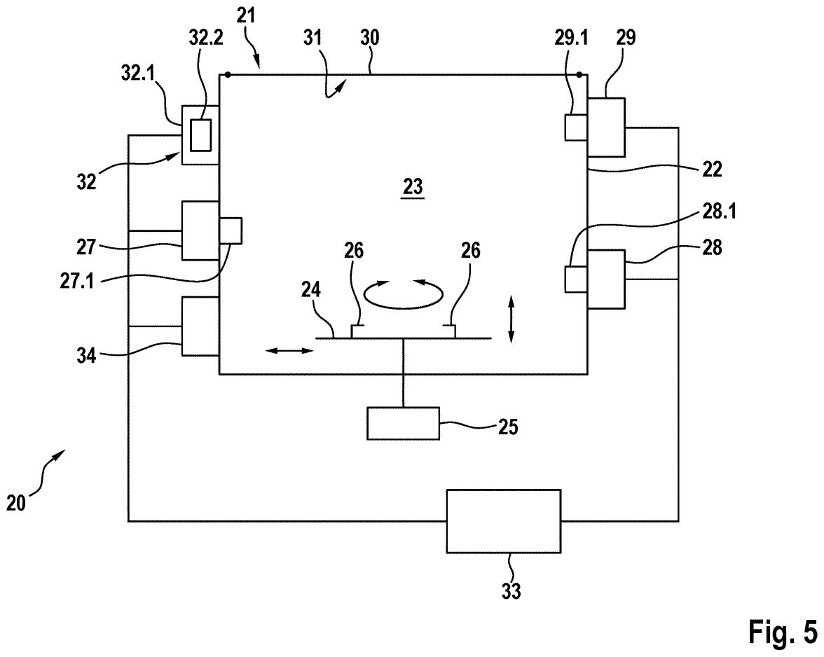

FIG. 5 shows a principle drawing of an apparatus 20 for conducting at least one measure to modify the optical properties of a three-dimensional object which has been manufactured via a volumetric 3d-printing process in accordance with an exemplary embodiment of the invention.

As will be apparent, the apparatus 20 can be or comprise at least one of a thermal treatment device configured to conduct a thermal treatment of a three-dimensional object as outlined above and/or an optical treatment device configured to conduct an optical treatment of a three-dimensional object as outlined above and/or a chemical treatment device configured to conduct a chemical treatment of a three-dimensional object as outlined above.

The apparatus 20 comprises a chamber 21 for receiving at least one three-dimensional object. The chamber 21 can comprise one or more walls 22 delimiting a chamber interior space 23. The chamber interior space 23 can be accessible through an opening 31. The opening can have a closure element assigned thereto, the closure element 30 being transferrable, particularly moveable in a translatory degree of freedom of motion and/or in a rotatory degree of freedom of motion, in a first state (open state) in which it provides access into the chamber interior space 23, and in a second state (closed state) in which it does not provide access into the chamber interior space 23 (which is exemplarily shown in FIG. 5). The closure element 30 can be built as or comprise a lid element, for instance.

The chamber 21 can comprise at least one support or suspension structure 24, e.g. a support plate, a suspension bracket, etc. for supporting or suspending a three-dimensional object in the chamber 21. Suspending a three-dimensional object in the chamber 21 can comprise a hanging arrangement of the three-dimensional object in the chamber 21. The support or suspension structure 24 can be arranged in the chamber interior space 23. The support or suspension structure 24 can be moveably supported in at least one degree of freedom of motion, such as e.g. a translational degree of freedom of motion along at least one translation axis and/or a rotational degree of freedom of motion about at least one rotational axis, as is exemplarily indicated by the double-arrows in FIG. 5. As a concrete example, the support or suspension structure 24 can be built as or comprise a rotating plate, a rotating suspension bracket, etc. To effect respective motions of the support or suspension structure 24 in the at least one degree of freedom of motion, an actuator device 25, such as e.g. an electric motor, can be assigned to the support or suspension structure 24. The support or suspension structure 24 can be provided with one or more fixing elements 26 configured to fix a three-dimensional object supported or suspended via the support or suspension structure 24 at the support or suspension structure 24. As such, it is assured that the three-dimensional object can be kept in position during motions of the support or suspension structure 24. Respective fixing elements 26 can be or comprise mechanical fixing elements, such as e.g. clamping elements, and/or magnetic fixing elements, such as e.g. permanent magnets or electromagnets, and/or pneumatic fixing elements, such as e.g. suction elements, for instance.

The apparatus 20 can further comprise a tempering unit 27 configured for heating the chamber 21, particularly the chamber interior space 23, to at least one temperature. The tempering unit 27 can particularly, be configured to dynamically adjust the temperature in the chamber 21. The tempering unit 27 can particularly, be configured to effect specific temperature profiles, e.g. including positive temperature ramps, negative temperature ramps, temperature plateaus, etc., in the chamber 21. The tempering unit 27 can be associated with at least one temperature sensor 27.1 assigned to the chamber 21 which enables a control of the temperature, particularly the implementation of closed-loop control of the temperature, in the chamber 21. A respective control of the temperature can be used to enable a control of the kinetics of the reaction between at least one chemical modifying agent and the three-dimensional object if the apparatus 20 is embodied as a chemical treatment device.

The apparatus 20 can also comprise a fluid supply unit 28, particularly a liquid or gas supply unit, connectable or connected with the chamber 21 which enables that the chamber 21, particularly the chamber interior space 23, can be filled with a gas and/or a liquid. If the apparatus 20 is embodied as a chemical treatment device, the gas and/or a liquid can be or contain the chemical modifying agent. The fluid supply unit 28 can be associated with at least one fluid sensor 28.1 assigned to the chamber 21 which enables a control of the concentration of gases and/or liquids in the chamber 21. If the apparatus 20 is embodied as a chemical treatment device, the at least one fluid sensor 28.1 can enable a control of the concentration of reactants and/or products of the chemical reaction between the chemical modifying agent and the three-dimensional object. As such, a closed-loop control of the concentration of gases and/or liquids, particularly reactants and/or products of the chemical reaction between the chemical modifying agent and the three-dimensional object, in the chamber 21 can be implemented. A respective control of the concentration can be used to enable a control of the kinetics of the reaction between the at least one chemical modifying agent and the three-dimensional object, if the apparatus 20 is embodied as a chemical treatment device.

The apparatus 20 can also comprise a pressure generating unit 29, e.g. a pump unit, configured to control a pressure level in the chamber 21, particularly in the chamber interior space 23. A respective pressure level can be a pressure level above or below a standard or reference pressure level which can be 1 bar, for instance. The pressure generating unit 29 can be associated with at least one pressure sensor 29.1 assigned to the chamber 21 which enables a control of the pressure, particularly the implementation of closed-loop control of the pressure, in the chamber 21. A respective control of the pressure can be used to enable a control of the kinetics of the reaction between the at least one chemical modifying agent and the three-dimensional object if the apparatus 20 is embodied as a chemical treatment device.

In embodiments in which the apparatus 20 is embodied as an optical treatment device, the apparatus 20 can further comprise an irradiation device 32 configured to irradiate a three-dimensional object with light of at least one wavelength for a specific time. The irradiation device 32 can comprise at least one irradiation unit 32.1 configured to irradiate a three-dimensional object with directed or undirected light of at least one wavelength, particularly at least one directed or undirected light beam of light of at least one wavelength, from at least one irradiation direction. The irradiation unit 32.1 can comprise one or more light sources 32.2 each configured to generate light of at least one wavelength. Each respective light source 32.2 can be configured to generate light having a wavelength ranging between 400 nm and 2000 nm, particularly between 400 nm and 900 nm, particularly between 430 nm and 800 nm. Additionally or alternatively, each respective light source can be configured to emit light having a wavelength in the microwave wavelength range, particularly ranging between 780 nm and 1 cm, or in the infrared wavelength range, particularly ranging between 1 mm and 10 cm. Each respective light source 32.2 can be built as or comprise at least one laser and/or at least one light emitting diode, for instance. It is conceivable that a first light source 32.2 is configured to generate light of a first wavelength or a first wavelength range and at least one further light source 32.2 is configured to generate light of at least one further wavelength or wavelength range, respectively which is different from the first wavelength or wavelength range, respectively. It is conceivable that a three-dimensional object is irradiated with light from multiple different directions which can be realized by arranging multiple irradiation units 32.1 in different orientations and/or positions relative to a three-dimensional object which is to be irradiated, and/or by moving at least one irradiation unit 32.1 relative to a three-dimensional object which is to be irradiated, and/or by moving a three-dimensional object which is to be irradiated relative to at least one irradiation unit 32.1, for instance.

In either embodiment, the apparatus 20 can comprise a hardware- and/or software-embodied controller 33 which can control operation of the tempering unit 27 and/or the fluid supply unit 28 and/or the pressure generating unit 29 and/or the irradiation unit 32.1 of the irradiation device 32 so as to control temperature parameters and/or atmosphere and/or pressure and/or irradiation parameters in the chamber 21. The controller 33 can particularly, control temperature and/or atmosphere and/or pressure and/or irradiation parameters in the chamber 21 based on sensor information provided from respective sensors 27.1, 28.1, 29.1, for instance.

Alternatively or additionally, the apparatus 20 can be associated with at least one sensor 34, e.g. a camera, configured to detect the optical properties, particularly the absorption properties and/or the transmission properties, of the three-dimensional object inside the chamber interior space 23 before and/or during and/or after the modification of the optical properties of the three-dimensional object which can be effected, as specified above, via a thermal treatment and/or an optical treatment and/or a chemical treatment. The sensor 34 can be arranged inside or outside the chamber interior space 23. The sensor values generated by the sensor 34 can be input to the controller 33 of the apparatus 20. The controller 33 can be configured to control temperature and/or atmosphere and/or pressure and/or irradiation parameters in the chamber 21 based on sensor information provided from the sensor 34.

Hence, the apparatus 20 is particularly, configured to conduct the second step S2 of the method.

FIG. 6 shows a principle drawing of a system 40 for manufacturing a three-dimensional object in accordance with an exemplary embodiment of the invention.

The system 40 comprises at least one volumetric 3d-printing apparatus 10 and at least one apparatus 20 as specified in FIG. 5.

As is apparent from FIG. 6, the volumetric 3d-printing apparatus 10 can comprise a container 13 defining a working volume 11 for receiving a photopolymerizable material and at least one radiation device 12 configured to emit light L of two wavelengths so as to irradiate the photopolymerizable material received in the working volume 11 with light of two different wavelengths. Particularly, the radiation device 12 of the volumetric 3d-printing apparatus 10 comprises first light sources 12.1, e.g. lasers, configured to emit light L1 of a first wavelength and a further light source 12.2, e.g. a DLP projector, configured to emit light L2 of a further wavelength which is different form the first wavelength.

The first light sources 12.1 are configured to irradiate light of the first wavelength L1 into the working volume 11 to generate a first light projection LP1 in the working volume 11. The first light projection LP1 can comprise multiple light beams traversing the working volume 11 in at least one light plane. The at least one light plane can also be deemed or denoted “common light plane”. The first light projection LP1 and the at least one light plane, respectively can also be deemed or denoted a “light sheet”. As an example, the radiation device 12 can comprise at least one optical element 12.3 for generating the at least one light plane in the working volume 11. The at least one optical element 12.3 can comprise at least one of a Powell-lens, a cylindrical lens, a diffractive optical element, etc. Additionally or alternatively, the first radiation device 12 can comprise a light deflection unit, such as e.g. a galvo-scanner, a polygon scanner, or a mirror (as is exemplarily indicated in FIG. 6) for generating the at least one light plane. The radiation device 12 can thus comprise a light plane generator or a light sheet generator. The light L1 as emitted by the first light sources 12.1 can comprise a first wavelength in the range of: 350 nm-500 nm, particularly 375 nm-450 nm, more particularly 385 nm-440 nm, more particularly 395 nm-420, more particularly 400 nm-410 nm, for instance. The light L1 of the first wavelength can comprise a spectrum of wavelengths, particularly at least partly covering the respective ranges. As an example, the first wavelength can range between 370 nm and 380 nm. Typically, the first wavelength will be chosen at least under consideration of the photochemical properties, particularly the photochromic properties, of molecules of the photoinitiator.

The radiation device 12 can be further configured to continuously project a plurality of images of light L2 emitted by the further light source 12.2 into the working volume 11. The light L2 emitted by the further light source 12.2 has a further wavelength different from the first wavelength. Each image of the light emitted by the further light source 12.2 can correspond to a specific portion, particularly a specific cross-section, of the at least one three-dimensional object to be manufactured with the volumetric 3d-printing apparatus 10. The radiation device 12 can thus also comprise an image projector. The light L2 as emitted by the further light source 12.2 can comprise a wavelength in the range of: 400 nm-1000 nm, particularly 425-750 nm, more particularly 450-675 nm, more particularly 500-650 nm, for instance. The light L2 of the further wavelength can comprise a spectrum of wavelengths, particularly at least partly covering the respective ranges. Typically, the further wavelength will be chosen at least under consideration of the photochemical properties, particularly the photochromic properties, of molecules of the photoinitiator.

As is further apparent from FIG. 6. the light L1 of the first wavelength intersects the light L2 of the further wavelength in the working volume 11. As such, the second light projection intersects the first light projection at a specific angle, particularly an angle of 90°. Hence, the at least one light plane generated by the first light sources 12.1 can be oriented at an angle, particularly at an angle of 90°, relative to the direction of projection of the plurality of images generated by the further light source 12.2. In such embodiments, the local polymerization process of the photopolymerizable material and, thus the formation of a three-dimensional object can occur in the region in which the projected images generated by the further light source 12.2 intersect the at least one light plane generated by the first light sources 12.1 (and vice versa). As indicated above, the local polymerization process of the photopolymerizable material and, thus the formation of a three-dimensional object can take place continuously (which is one characteristic of volumetric 3d-printing relative to conventional additive manufacturing principles).

Typically, the projection of the plurality of images generated by the further light source 12.2 does not only overlay the light plane generated by the first light sources 12.1 but also has its focus plane in the light plane.

In the exemplary embodiment of FIG. 6, the working volume 11 is moveable relative to the irradiation device 12 during the volumetric 3d-printing process as is exemplarily indicated by the double-arrows in FIG. 6. In such embodiments, the irradiation device 12 can be not moveable (stationary) relative to the working volume 11. As such, the exemplary embodiment of FIG. 6, can particularly cover volumetric 3d-printing processes such as e.g. xolography, CAL or other tomographic-based volumetric 3d-printing processes, for example.

In other exemplary embodiments, the working volume 11 is not moveable (stationary) relative to the irradiation device 12 during the volumetric 3d-printing process. In such embodiments, the irradiation device 12 can be moveable relative to the working volume 11.

Even though the exemplary embodiment of FIG. 6 shows an exemplary configuration with two first light sources 12.1, other embodiments with only one first light source 12.1 and with more than two first light sources 12.1 are contemplated herein.

In either case, the first step of the method can comprise a volumetric 3d-printing process in which a photopolymerizable material is arranged, e.g. via deposition, on a substrate and irradiated with light of at least one wavelength for photopolymerizing the photopolymerizable material to form a three-dimensional object on the substrate. The three-dimensional object can be or comprise a structure and/or a pattern on the substrate. The photopolymerizable material can be provided as a layer, particularly a layer having a layer thickness ranging between 5 nm and 1000 nm, particularly between 10 nm and 1000 nm. The substrate can be or comprise an electronic and/or optical component. Particularly, the substrate can be or comprise a semiconductor, e.g. a wafer. In such embodiments of the method, the second step of the method can be omitted.

As such, the method can comprise a volumetric 3d-printing process in which a photopolymerizable material is arranged on a substrate and is irradiated with light of at least one wavelength for photopolymerizing the photopolymerizable material to form a three-dimensional object on the substrate, the three-dimensional object manufactured in accordance with the volumetric 3d-printing process having specific optical properties. Such a method can be implemented as a lithography-process, particularly for processing substrates, particularly electronic or optical substrates, such as e.g. semiconductors or wafers, respectively.

Preferably, in a respective lithography process a pattern or structure is formed on a substrate, preferably the substrate is a silicon wafer. A lithography process can comprise the use of a photoresist, preferably a negative photoresist, wherein the photoresist comprises a dual color photoinitiator. Hence, the photopolymerizable material can comprise a photoresist or vice versa.

1. A method for manufacturing a three-dimensional object, the method comprising:
a) a volumetric 3d-printing process in which a photopolymerizable material is irradiated with light of at least one wavelength for photopolymerizing the photopolymerizable material to form a three-dimensional object, the three-dimensional object manufactured in accordance with the volumetric 3d-printing process having specific optical properties; and
b) conducting at least one measure to modify the optical properties of the three-dimensional object.

2. The method of claim 1, wherein the at least one measure comprises modifying the optical properties of the three-dimensional object resulting in a decrease of the absorption properties of the three-dimensional object for at least one wavelength in a wavelength range between 300 nm and 2000 nm, particularly 350 nm and 900 nm, and/or in an increase of the transmissive properties of the three-dimensional object for at least one wavelength in the wavelength range between 300 nm and 2000 nm, particularly in the wavelength range between 350 nm and 900 nm, more particularly in the wavelength range between 400 nm and 800 nm.

3. The method of claim 1, wherein the at least one measure of conducting at least one measure to modify the optical properties of the three-dimensional object comprises modifying the optical properties of the three-dimensional object resulting in that an average transmission or an integral of the transmission between 300 nm and 2000 nm, particularly between 350 nm and 900 nm, more particularly between 400 nm and 800 nm, is increased by at least 1%, particularly at least 2%, more particularly at least 3%, more particularly at least 4%, more particularly at least 5%, more particularly at least 7.5%, more particularly at least 10%, more particularly at least 15%, more particularly at least 20%, more particularly at least 25%, more particularly at least 30%, more particularly at least 35%, more particularly at least 40%, more particularly at least 45%, more particularly at least 50%, particularly relative to a state of the three-dimensional object before it has undergone the at least one measure; and/or wherein
the at least one measure of conducting at least one measure to modify the optical properties of the three-dimensional object comprises modifying the optical properties of the three-dimensional object resulting in that an average absorption or an integral of the absorption between 300 nm and 2000 nm, particularly between 350 nm and 900 nm, more particularly between 400 nm and 800 nm, is decreased by at least 1%, particularly at least 2%, more particularly at least 3%, more particularly at least 4%, more particularly at least 5%, more particularly at least 7.5%, more particularly at least 10%, more particularly at least 15%, more particularly at least 20%, more particularly at least 25%, more particularly at least 30%, more particularly at least 35%, more particularly at least 40%, more particularly at least 45%, more particularly at least 50% particularly relative to a state of the three-dimensional object before it has undergone the at least one measure.

4. The method of claim 1, wherein the at least one measure comprises modifying the optical properties of the three-dimensional object resulting in an average or integrated absorption per mm of thickness of the three-dimensional object of less than 0.5, particularly less than 0.3, more particularly less than 0.2, more particularly less than 0.1, in a wavelength range between 300 nm and 2000 nm, particularly 350 nm and 900 nm, more particularly between 400 nm and 800 nm, or wherein the absorption per mm of thickness of the three-dimensional object is less than 0.5, particularly less than 0.3, more particularly less than 0.2, more particularly less than 0.1, for each wavelength in the wavelength range between 300 nm and 2000 nm, particularly between 350 nm and 900 nm, more particularly between 400 nm and 800 nm, or wherein the absorption per mm of thickness of the three-dimensional object is less than 0.5, particularly less than 0.3, more particularly less than 0.2, more particularly less than 0.1, for each wavelength in the wavelength range between 300 nm and 2000 nm, particularly between 350 nm and 900 nm, more particularly between 400 nm and 800 nm.

5. (canceled)

6. The method of claim 1, wherein the at least one measure comprises a thermal treatment of the three-dimensional object which thermal treatment comprises tempering the three-dimensional object for a specific time at at least one specific temperature, wherein particularly, the specific time particularly ranges between 0.5 min and 60 min, particularly between 1 min and 30 min, and/or wherein the at least one specific temperature ranges between 50° C. and 150° C., particularly between 75° C. and 125° C., wherein particularly, the specific time particularly ranges between 0.5 min and 60 min, particularly between 1 min and 30 min, and/or wherein the at least one specific temperature ranges between 50° C. and 150° C., particularly between 75° C. and 125° C.

7. (canceled)

8. (canceled)

9. The method of claim 1, wherein the at least one measure comprises an optical treatment of the three-dimensional object which optical treatment comprises irradiating the three-dimensional object with light of at least one specific wavelength for a specific time with a specific light intensity, wherein particularly, the specific time particularly ranges between 0.5 min and 180 min, particularly between 5 min and 60 min, and/or wherein the at least one specific wavelength ranges between 350 nm and 1000 nm, particularly between 400 nm and 800 nm, more particularly between 350 nm and 500 nm or between 420 nm and 800 nm.

10. (canceled)

11. (canceled)

12. The method of claim 9, wherein the three-dimensional object is irradiated for the specific time and light intensity with the light of the at least one specific wavelength while the three-dimensional object is in a working volume in which it has been formed in step a), and/or wherein the three-dimensional object is subject to tempering after irradiating the three-dimensional object for the specific time with light of the at least one specific wavelength, wherein the tempering particularly comprises heating the three-dimensional object to a temperature ranging between 50° C. and 150° C. for a time ranging between 1 min and 60 min, particularly 5 min and 30 min.

13. (canceled)

14. The method of claim 1, wherein the at least one measure comprises a chemical treatment of the three-dimensional object which chemical treatment comprises chemically altering, particularly via oxidizing and/or reducing chromophore molecules, particularly residual photoinitiator molecules, of the three-dimensional object, the molecules having a (visible) color in the visible wavelength spectrum ranging between 380 nm and 750 nanometers with at least one chemical modifying agent, wherein the at least one chemical modifying agent is added to the photopolymerizable material before and/or during formation of the three-dimensional object, or wherein the at least one chemical modifying agent is added to the photopolymerized material after forming the three-dimensional object by placing the three-dimensional object in a solution containing the at least one chemical modifying agent for a specific time, wherein the at least one chemical modifying agent migrates from the solution into the three-dimensional object, and optionally residual co-initiator and/or photoinitiator migrates from the three-dimensional object into the solution.

15. (canceled)

16. (canceled)

17. The method of claim 14, wherein the solution comprises a solvent, particularly an inert organic solvent, e.g. cyclohexane or ethanol, and/or wherein the at least one chemical modifying agent is a gas, wherein the three-dimensional object is disposed in an atmosphere containing the gas.

18. (canceled)

19. The method of claim 14, wherein the at least one chemical modifying agent is configured to alter the chromophore properties of initial chromophores, particularly residual photoinitiator molecules, of the photopolymerizable material and/or chromophores resulting from the photopolymerization process, of the three-dimensional object or the at least one chemical modifying agent is configured to generate a reactive agent configured to alter the chromophore properties of the chromophore molecules, particularly residual photoinitiator molecules, of the three-dimensional object under the influence of electromagnetic energy, particularly thermal energy and/or radiation energy.

20. (canceled)

21. (canceled)

22. The method of claim 1, wherein the volumetric 3d-printing process comprises irradiating the photopolymerizable material with light of the at least one wavelength in a working volume, wherein the working volume is moved relative to radiation device emitting the light of the at least one wavelength during the volumetric 3d-printing process, or wherein the working volume is not moved relative to a radiation device emitting the light of the at least one wavelength during the volumetric 3d-printing process.

23. (canceled)

24. The method of claim 1, wherein the volumetric 3d-printing process comprises at least one of: multi-photon photopolymerization, particularly multi-color photopolymerization, more particularly dual-color photopolymerization, of the photopolymerizable material, and tomographic reproductions or tomographic back projections, particularly via projecting light images from multiple directions into a working volume.

25. (canceled)

26. The method of claim 1, wherein the photopolymerizable material comprises a photopolymerizable polymer resin and a photoinitiator, particularly dual-color photoinitiator, more particularly a naphthopyran, a naphthopyran-based or spiropyran-based photoinitiator, which can be converted, particularly via sequential optical excitation, into a reactive state in which the molecules of the photoinitiator locally trigger a polymerization reaction of the polymerizable polymer resin.

27. (canceled)

28. (canceled)

29. (canceled)

30. (canceled)

31. (canceled)

32. The method of claim 1, wherein the photopolymerizable material is arranged on a substrate and the method comprises irradiating the photopolymerizable material on the substrate with light of at least one wavelength for photopolymerizing the photopolymerizable material to form a three-dimensional object on the substrate.

33. Apparatus for conducting at least one measure to modify the optical properties of a three-dimensional object which has been manufactured via a volumetric 3d-printing process, the apparatus comprising at least one of a thermal treatment device configured to conduct at least one thermal treatment of a three-dimensional object which has been manufactured via a volumetric 3d-printing process which thermal treatment comprises tempering the three-dimensional object at at least one specific temperature for a specific time; an optical treatment device configured to conduct an optical treatment of a three-dimensional object which has been manufactured via a volumetric 3d-printing process which optical treatment comprises irradiating the three-dimensional object with light of at least one wavelength for a specific time, and a chemical treatment device configured to conduct at least one chemical treatment of a three-dimensional object which has been manufactured via a volumetric 3d-printing process which chemical treatment comprises effecting a reaction between at least one chemical modifying agent and the three-dimensional object.

34. The apparatus of claim 33, wherein at least one of the thermal treatment device, the optical treatment device, and the chemical treatment device comprises at least one chamber configured for receiving a three-dimensional object to be tempered, wherein the at least one chamber comprises one or more walls delimiting a chamber interior space,
wherein the chamber of at least one of the thermal treatment device, the optical treatment device, and the chemical treatment device comprises at least one support or suspension structure for supporting or suspending a three-dimensional object in the at least one chamber, wherein the at least one support or suspension structure is arranged in the chamber interior space, wherein the at least one support or suspension structure is moveably supported in at least one degree of freedom of motion, wherein particularly the at least one support or suspension structure is provided with one or more fixing elements configured to fix at least one three-dimensional object supported or suspended via the at least one support or suspension structure at the at least one support or suspension structure.

35. (canceled)

36. (canceled)

37. The apparatus of claim 34, wherein at least one of the thermal treatment device, the optical treatment device, and the chemical treatment device comprises at least one of:
a tempering unit configured for heating the at least one chamber, particularly the chamber interior space, to at least one temperature;
a fluid supply unit, particularly a gas supply unit, connectable or connected with the at least one chamber which enables that the at least one chamber, particularly the chamber interior space, can be filled with at least one fluid, particularly at least one gas;
a pressure generating unit, e.g. a pump unit, configured to control a pressure level in the at least one chamber, particularly in the chamber interior space;
a hardware- and/or software-embodied controller which can control operation of the tempering unit and/or the fluid supply unit and/or the pressure generating unit so as to control temperature and/or atmosphere and/or pressure in the at least one chamber; wherein the controller is particularly configured to control temperature and/or atmosphere and/or pressure in the at least one chamber based on sensor information provided from one or more sensors assigned to the tempering unit and/or the fluid supply unit and/or the pressure generating unit;
at least one sensor, e.g. a camera, configured to detect the optical properties, particularly the absorption properties and/or the transmission properties, of the three-dimensional object inside the chamber interior space before and/or during and/or after a step of modifying the optical properties of a three-dimensional object in the chamber, and
a controller assigned to the tempering unit and/or the fluid supply unit and/or the pressure generating unit, wherein the controller is configured to control temperature and/or atmosphere and/or pressure in the at least one chamber based on sensor information provided from the at least one sensor.

38. (canceled)

39. (canceled)

40. (canceled)

41. (canceled)

42. (canceled)

43. A system for manufacturing a three-dimensional object, the system comprising: at least one volumetric 3d-printing apparatus and at least one apparatus for conducting at least one measure to modify the optical properties of the three-dimensional object which comprises at least one of a thermal treatment device configured to conduct at least one thermal treatment of a three-dimensional object which has been manufactured via a volumetric 3d-printing process which thermal treatment comprises tempering the three-dimensional object at at least one specific temperature for a specific time; an optical treatment device configured to conduct an optical treatment of a three-dimensional object which has been manufactured via a volumetric 3d-printing process which optical treatment comprises irradiating the three-dimensional object with light of at least one wavelength for a specific time, and a chemical treatment device configured to conduct at least one chemical treatment of a three-dimensional object which has been manufactured via a volumetric 3d-printing process which chemical treatment comprises effecting a reaction between at least one chemical modifying agent and the three-dimensional object.

44. A method for manufacturing a three-dimensional object, the method comprising a volumetric 3d-printing process in which a photopolymerizable material is arranged on a substrate and is irradiated on the substrate with light of at least one wavelength for photopolymerizing the photopolymerizable material to form a three-dimensional object on the substrate.

45. The method of claim 9, wherein the at least one chemical modifying agent is or comprises at least one of an oxidizing agent, particularly an oxidizing acid, particularly a peroxyacid, or at least one reducing agent, particularly a reducing base, or a salt, particularly a sulfonium salt or an iodonium salt, configured to alter, particularly degrade, chromophores, particularly residual photoinitiator molecules, 10 of the three-dimensional object, and/or wherein the at least one chemical modifying agent is or comprises a chlorine-based substance, particularly chlorine, hypochlorite, chlorine dioxide, or an oxygen-based substance, particularly ozone, oxygen, peroxide, perborate, percarbonate, peracetic acid, or chlorine or a chlorine-compound.
